(19) United States
(12) Patent Application Publication
(10) Pub. No.: US 2024/0134884 A1
(43) Pub. Date: Apr. 25, 2024

(54) METHODS AND APPARATUS FOR RECOMMENDATION SYSTEMS WITH ANONYMIZED DATASETS

(71) Applicant: Intel Corporation, Santa Clara, CA (US)

(72) Inventors: Chendi Xue, Austin, TX (US); Jian Zhang, Shanghai (CN); Poovaiah Manavattira Palangappa, San Jose, CA (US); Rita Brugarolas Brufau, Hillsboro, OR (US); Ke Ding, Saratoga, CA (US); Ravi H. Motwani, Fremont, CA (US); Xinyao Wang, Shanghai (CN); Yu Zhou, Shanghai (CN); Aasavari Dhananjay Kakne, Santa Clara, CA (US)

(21) Appl. No.: 18/395,311

(22) Filed: Dec. 22, 2023

Related U.S. Application Data
(60) Provisional application No. 63/513,563, filed on Jul. 13, 2023.

(51) Int. Cl. G06F 16/28; G06F 16/23

(52) U.S. Cl. CPC G06F 16/285; G06F 16/23

(57) ABSTRACT

Systems, apparatus, articles of manufacture, and methods are disclosed to preserve privacy in a user dataset including interface circuitry, machine readable instructions, and programmable circuitry to determine a data usage type for each one of a plurality of user data features in a first dataset, classify the data usage type associated with each user data feature of the plurality of user data feature into a feature category, apply at least one feature engineering mechanism to feature categories of the data usage types of the plurality of user data features, select, based on application of feature engineering, a subset of the plurality of user data features for a feature selection training model, and output a second dataset based on the subset of the plurality of user data for the feature selection training model, the second dataset to include fewer user data features than the first dataset.

### FIELD OF THE DISCLOSURE

This disclosure relates generally to machine learning and, more particularly, to methods and apparatus for recommendation systems with anonymized datasets.

### BACKGROUND

A recommendation system utilizes an artificial intelligence algorithm associated with machine learning to suggest or recommend products to consumers. For example, a recommendation system can use past purchases, demographics, and/or search history to suggest a product to a consumer. Such recommendation systems may be trained using various datasets such as, for example, demographics of people, website visitor records, advertisement records, user activity records, etc. After training on such datasets, the recommendation system may be deployed to analyze available information to make a recommendation that is personalized to a person, group, destination, etc. For example, a recommendation system may process a user's past activity and demographics to recommend an advertisement to be presented to the person, recommend a product to be advertised to the person, recommend a website for the person to visit, etc.

### BRIEF DESCRIPTION OF THE DRAWINGS

FIG. 1 is an example pipeline diagram for feature engineering using example feature organizer circuitry for feature engineering on a privacy preserving dataset.

FIG. 2 illustrates an example process for feature classification as part of the feature organizer circuitry of FIG. 1.

FIG. 3 illustrates an example of timeframe count encoding.

FIG. 4 illustrates an example of incremental count encoding.

FIG. 5 illustrates an example of context feature generation based on context features.

FIG. 6 illustrates an example of feature generation within a same partite.

FIG. 7 illustrates an example of feature generation across a partite.

FIG. 8 is a block diagram of an example implementation of the feature organizer circuitry of FIG. 1.

FIG. 9 is a flowchart representative of example machine-readable instructions and/or example operations that may be executed, instantiated, and/or performed by example programmable circuitry to implement the feature organizer circuitry of FIG. 1.

FIG. 10 is a flowchart representative of example machine-readable instructions and/or example operations that may be executed, instantiated, and/or performed by example programmable circuitry to implement the feature organizer circuitry of FIG. 1 to perform data usage type analysis in accordance with teachings disclosed herein.

FIG. 11 is a flowchart representative of example machine-readable instructions and/or example operations that may be executed, instantiated, and/or performed by example programmable circuitry to implement the feature organizer circuitry of FIG. 1 to initiate anonymous feature classification in accordance with teachings disclosed herein.

FIG. 12 is a flowchart representative of example machine-readable instructions and/or example operations that may be executed, instantiated, and/or performed by example programmable circuitry to implement the feature organizer circuitry of FIG. 1 to perform enhanced feature engineering in accordance with teachings disclosed herein.

FIG. 13 is a flowchart representative of example machine-readable instructions and/or example operations that may be executed, instantiated, and/or performed by example programmable circuitry to implement the feature organizer circuitry of FIG. 1 to perform feature generation in accordance with teachings disclosed herein.

FIG. 14 is a flowchart representative of example machine-readable instructions and/or example operations that may be executed, instantiated, and/or performed by example programmable circuitry to implement the feature organizer circuitry of FIG. 1 to perform feature selection in accordance with teachings disclosed herein.

FIG. 15 is a flowchart representative of example machine-readable instructions and/or example operations that may be executed, instantiated, and/or performed by example programmable circuitry to implement a computing system of FIG. 8 to cause the computing system to train a neural network to generate feature importance model(s) in accordance with teachings disclosed herein.

FIG. 16 is an example of score comparison charts showing normalized cross entropy and corresponding improvements in user privacy.

FIG. 17 is a block diagram of an example processing platform including programmable circuitry structured to execute, instantiate, and/or perform the example machine readable instructions and/or perform the example operations to implement the techniques disclosed herein.

FIG. 18 is a block diagram of an example processing platform structured to execute the instructions of FIG. 15 to implement the computing system of FIG. 8.

FIG. 19 is a block diagram of an example implementation of the programmable circuitry of FIG. 17.

FIG. 20 is a block diagram of another example implementation of the programmable circuitry of FIG. 17.

FIG. 21 is a block diagram of an example software/firmware/instructions distribution platform (e.g., one or more servers) to distribute software, instructions, and/or firmware (e.g., corresponding to the example machine readable instructions to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Recommendation systems can identify patterns in consumer-based behavior towards a service or product. However, a challenge of recommendation systems lies in achieving accurate predictions while preserving the privacy of user data. Some recommendation systems rely on accessing sensitive user information (e.g., browsing history, purchase behavior, and/or demographic data) to perform feature engineering. In machine learning, a feature is a numeric representation of raw data. Feature engineering is the process of assembling the features given the data, model, and/or task to facilitate machine learning (e.g., to determine a significance or lack of significance of features within a dataset. There are a variety of feature engineering techniques that can be leveraged to develop features for recommendation systems, including multi-modal feature extraction and/or data augmentation. Feature engineering techniques may raise concerns regarding user privacy and data security when training on datasets that include sensitive/confidential/private information such as user-identifying information.

The emergence of stringent privacy regulations, including the General Data Protection Regulation (GDPR) and similar mandates, emphasizes the importance of protecting personal data and ensuring compliance with privacy standards. Organizations must navigate the challenge of effectively performing feature engineering without de-anonymizing the data, thereby safeguarding the privacy of users while maintaining the quality of models.

Methods and apparatus disclosed herein provide a comprehensive and generalizable feature engineering pipeline for building recommendation systems utilizing a privacy-preserved dataset. In examples disclosed herein, data is processed with anonymous features and output is generated with enriched data for training to improve accuracy. In examples disclosed herein, data usage type analysis, anonymous feature classification, enhanced feature engineering and/or feature selection can be performed to identify and select relevant features for training machine learning models with the selected features. As such, training score(s) can be identified without exposing any confidential information within the data, thereby protecting the privacy of the original input data, and improving overall data learnability.

In examples disclosed herein, a feature engineering-based pipeline can be used to preserve dataset privacy and can be generalized to any recommendation systems, enriching feature numbers, identifying hidden information within the input datasets, and enhancing dataset expressivity. For example, conventional feature engineering requires data scientists to manually classify features and/or iteratively assign different feature engineering methods to feature columns associated with the input data. In examples disclosed herein, a classification method is introduced to classify features based on feature usage type, clustering, and/or distribution. Additionally, methods and apparatus disclosed herein permit the enhancement of conventional feature engineering methods by replacing missing values with value predictions and performing numerical feature descritization, partitioned count encoding, time frame count-based encoding, incremental count encoding, feature-to-feature target encoding, and/or multi-class feature encoding.

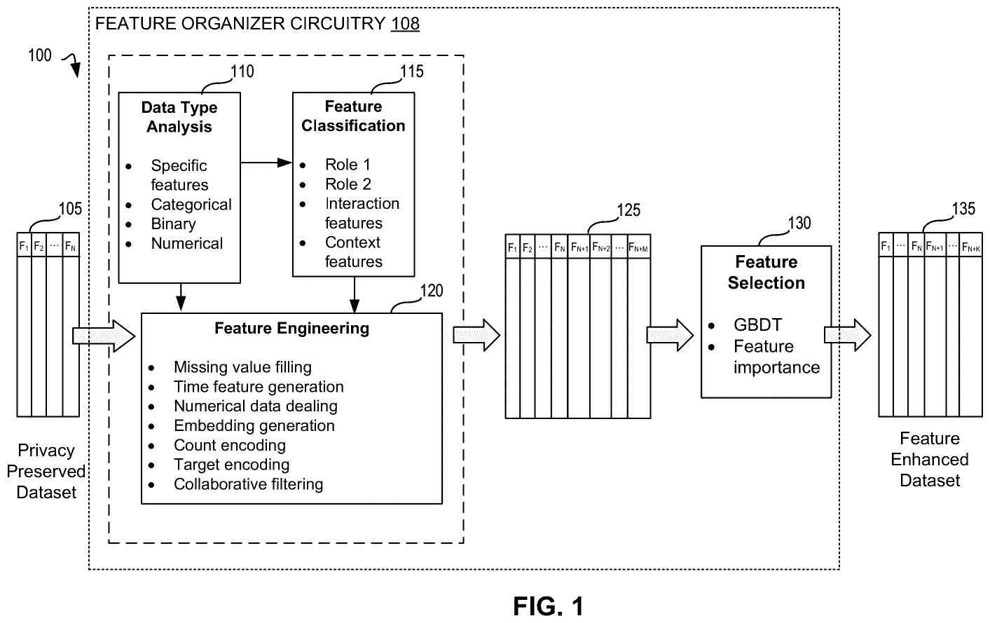

FIG. 1 is an example pipeline diagram 100 for feature engineering using example feature organizer circuitry for feature engineering on a privacy preserving dataset. In examples disclosed herein, a feature engineering pipeline is introduced for privacy-preserved dataset(s) to enhance feature selection. For example, recommendation systems can be used for recommending relevant products to customers of electronic commerce. Such recommendation systems use data-based feedback and ratings to predict user preferences and/or generate content tailored to user interests. Generally, recommendation systems collect user data, including ratings and/or browsing history, to assist with identifying and/or predicting user preferences. As such, the recommendation systems may have access to sensitive user information that could jeopardize user privacy when data breaches and/or cyberattacks occur. In response, service providers implement additional security measures to protect user privacy. Privacy-preserved dataset(s) are datasets that feature personalized content while accounting for user privacy (e.g., using cryptography and/or other privacy-preserving methods to avoid exposing private information). As used herein, the term privacy preserved dataset (also known as anonymized dataset) refers to a dataset in which at least one data element (e.g., one column of data) has been modified from its original form to remove, obfuscate, disguise, hide, or otherwise prevent revealing data that is deemed private, protected, confidential, etc. For example, data may be replaced with an encrypted copy of the data, data may be removed (e.g., a credit card number may be detected and removed from the data while leaving the remaining data such as credit card type), data may be replaced with a unique identifier known to a data owner but not to the recommendation system creator, etc.

In examples disclosed herein, such privacy-preserved datasets can be used for identification of relevant features for recommendation systems without exposing any confidential information within the data, while improving the overall quality and accuracy of the resulting assessments using the input privacy-preserved datasets (e.g., to generate a recommendation for a user). In examples disclosed herein, the feature organizer circuitry 108 augments and enriches the privacy-preserved dataset(s) using privacy preserving feature engineering, bipartite graph neural networks, and/or similarity-based graph neural networks, which can be generalized to different types of privacy-preserving recommendation systems.

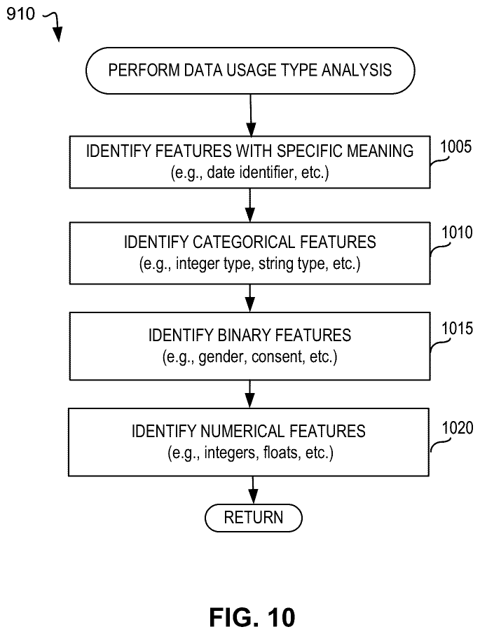

In the example of FIG. 1, a privacy-preserved dataset 105 is received by the feature organizer circuitry 108. The feature organizer circuitry 108 performs multiple analyses on the privacy-preserved dataset 105, including example data type analysis 110, example feature classification 115, and example feature engineering 120. For example, in data type analysis 110, the feature organizer circuitry 108 performs an assessment of the input privacy-preserved dataset to categorize features of the dataset into different categories (e.g., specific features, categorical features, binary features, numerical features, etc.), as described in more detail in connection with FIG. 10. For example, performing data type analysis 110 allows for determining the data usage type associated with each feature (e.g., if the data usage type is not already known and/or identifiable). Once the data usage type is identified, the feature organizer circuitry 108 performs feature classification 115. For example, a given input dataset associated with a recommendation system can include two distinct roles (e.g., a first role representing users and a second role representing advertisements).

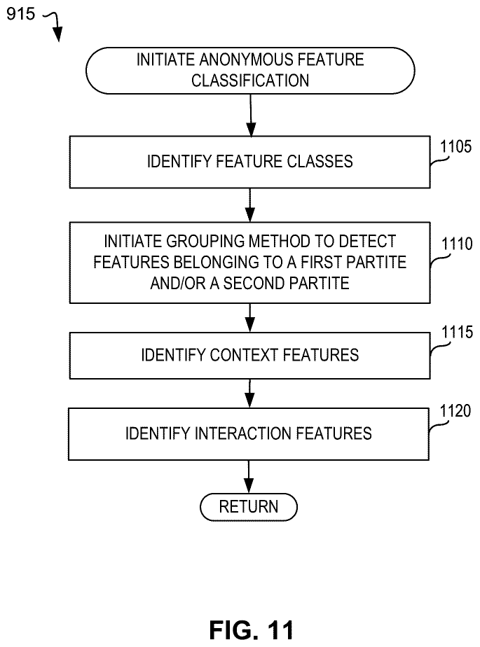

However, due to the privacy preservation transformations performed on the dataset (e.g., resulting in the privacy-preserved dataset 105), it is difficult to distinguish between data associated with the users and data associated with the advertisements. In examples disclosed herein, the feature organizer circuitry 108 assigns users to “Role 1” and advertisements to “Role 2” or vice versa, as shown in connection with the feature classification 115. As such, the feature organizer circuitry 108 classifies the features into one of four classes (e.g., Role 1 features, Role 2 features, context features, and/or interaction features), as described in connection with FIG. 11. In some examples, the feature organizer circuitry 108 performs feature engineering 120 once the data type analysis 110 and/or the feature classification 115 is completed. For example, feature classification 115 can rely on results of the data type analysis 110 by processing only identified categorical feature(s) and excluding all numerical features.

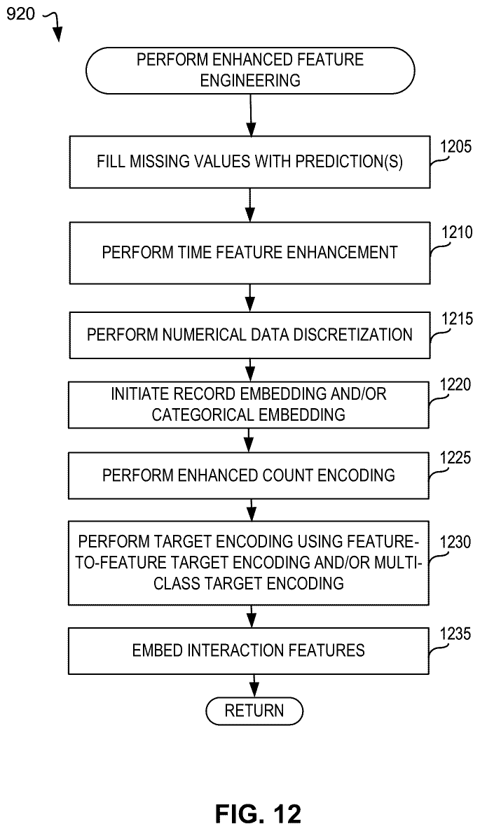

The feature organizer circuitry 108 performs feature engineering 120 using the data from the data type analysis 110 and/or the feature classification 115. For example, the feature organizer circuitry 108 performs missing value filling, time feature generation, numerical data deadline, embedding generation, count encoding, target encoding, and/or collaborative filtering, as described in more detail in connection with FIG. 12. For example, the feature organizer circuitry 108 can perform missing value filling to improve the dataset, normalization for numerical features for performance improvement, discretization for numerical features to make dense features more robust, time related feature transformation to improve predictive performance, feature-to-feature target encoding of binary features, partitioned count encoding using small cardinality features to act as a partitioning key for other features, and/or timeframe count encoding to calculate count encoding values.

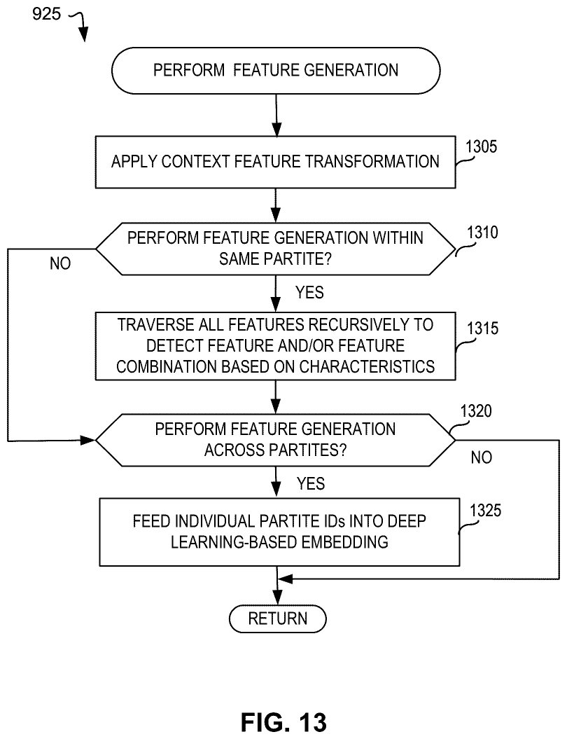

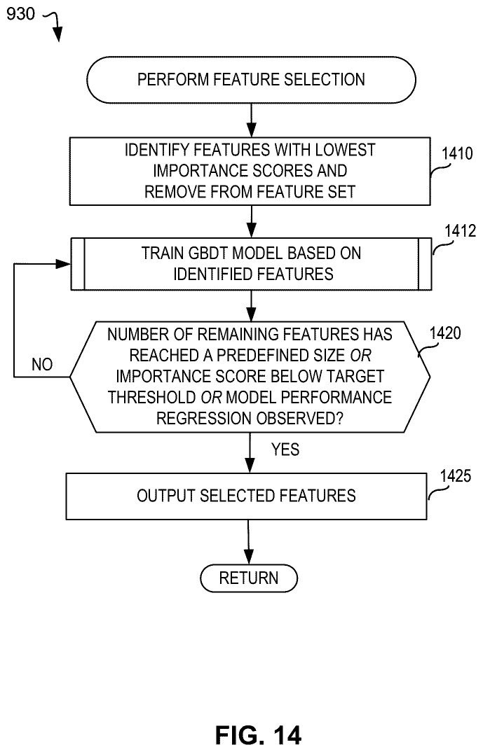

In some examples, the feature organizer circuitry 108 uses deep learning methods to generate new interaction features, thereby enhancing the dataset, as described in more detail in connection with FIG. 13. As such, the feature organizer circuitry 108 outputs an example updated feature dataset 125. The feature organizer circuitry 108 uses the updated feature dataset 125 to perform example feature selection 130. For example, the feature organizer circuitry 108 uses gradient boosted decision tree-based (GBDT) models to identify features with high and low importance, as described in more detail in connection with FIG. 14. The feature organizer circuitry 108 evaluates the resulting features to determine which features have the highest impact in the final performance score, resulting in a narrowed down subset of features (e.g., feature enhanced dataset 135) that provides the best performance for application by a recommendation system.

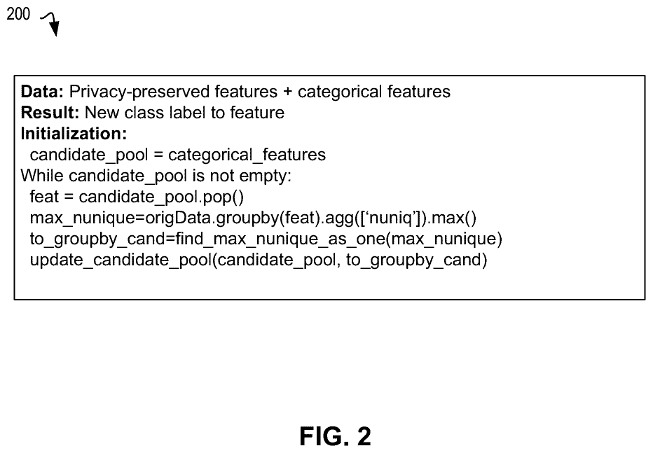

FIG. 2 illustrates an example process 200 for feature classification as part of the feature organizer circuitry 108 of FIG. 1. As described in connection with FIG. 1, feature classification 115 includes assigning users and advertisements to a specific role in the dataset (e.g., Role 1, Role 2, etc.), such that every feature can be categorized into one of four classes, including context features independent to either Role 1 or Role 2, and interaction features. For example, the feature organizer circuitry 108 of FIG. 1 uses recursive distribution-based feature classification for performing the categorization. FIG. 2 illustrates an example code used by the feature organizer circuitry 108 to identify features that belong to each role (e.g., Role 1, Role 2, etc.). For example, by combining several features over time, the feature organizer circuitry 108 profiles a certain role. By starting with a single feature, the feature organizer circuitry 108 uses the single feature as a partition key to obtain a number of unique values (e.g., indicated by nunique) for other features, proceeding to recursively add more features as partition key(s) and obtain the number of unique values for the remaining features until some feature nunique keys consistently maintain a value of one or zero.

In some examples, the feature organizer circuitry 108 uses distribution partitioning to identify context features. For example, if a feature remains ungroupable with other features but displays stable distribution across different time-frame(s), the feature organizer circuitry 108 identifies such a feature as a context feature. Context features can include a date, location, or other objective context related to the occurrence of events. Once the feature organizer circuitry 108 assigns context features and role features, the remaining features are classified as interaction features, which connect Role 1 and Role 1 features. Such features can show a high correlation to certain role features but are not grouped with a nunique having a value of one. In some examples, the feature organizer circuitry 108 includes a second level of feature classification based on the number of unique values of each feature. For example, categorical features with less than ten unique values (e.g., where some values dominate the distribution), are classified as partition features (e.g., gender, language, etc.). Separately, features with ten to one hundred unique values and nonuniform distribution are classified as both partition features and encoder features (e.g., age) and features with a large number of unique values are classified as encoder features and different time-frame based encoder features. To group all features within the same role, the feature organizer circuitry 108 generates a new feature (e.g., group id) and classifies group id features as role identifier features.

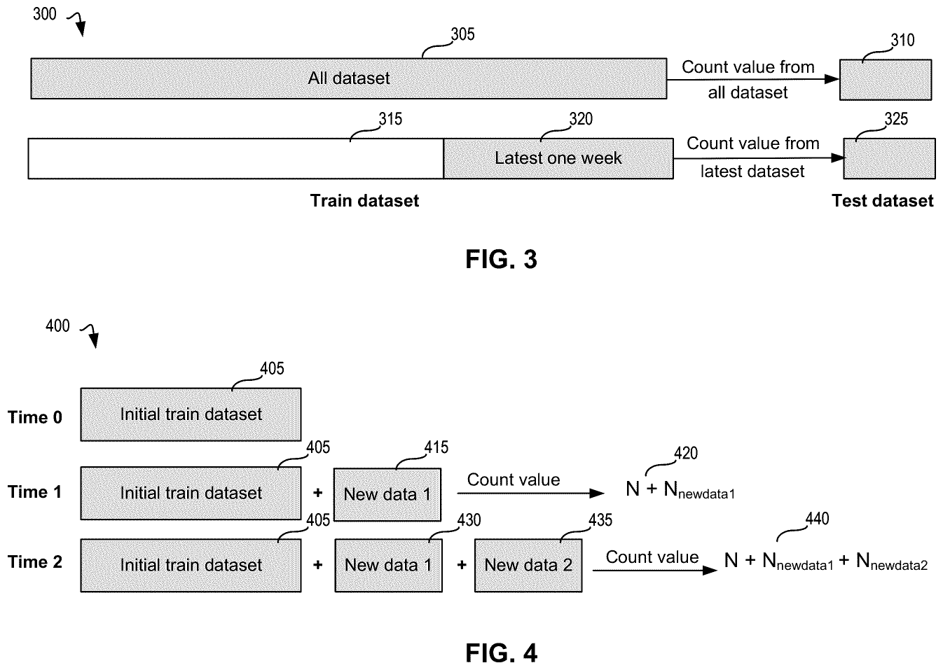

FIG. 3 illustrates an example 300 of timeframe count encoding. For example, timeframe count encoding is part of the feature engineering of independent features and role features (e.g., feature engineering 120 of FIG. 1). Timeframe count encoding is a variation of partitioned count encoding, which uses small cardinality features to act as partitioning keys for other features. For example, these keys are grouped to produce new distinct values, and then perform count encoding on the newly produced features. Some features in the test datasets can contain several new values, which miss the corresponding encoding data. Timeframe count encoding, on the other hand, focuses on a time-based assessment of the data. For example, a span of the last seven days prior to a current day can be selected to calculate the count encoding values. The feature organizer circuitry 108 of FIG. 1 performs timeframe count encoding to keep track of the newest information and works better for a system that constantly receives new data. In the example of FIG. 3, an example first dataset 305 can include an entire span of data associated with the timeframe when the data was collected. As such, the feature organizer circuitry 108 obtains an example first count value 310 from the entire dataset. When the feature organizer circuitry 108 selects a sub-set of the data (e.g., latest one week 320) that does not include data tied to an older time interval 315, the feature organizer circuitry 108 identifies a second count value 325 from the selected sub-set of the data. In general, count encoding allows for the use of statistics to obtain frequencies of occurrences, which is particularly useful when dealing with high-cardinality categorical features.

FIG. 4 illustrates an example 400 of incremental count encoding. As part of feature engineering 120 of FIG. 1, the feature organizer circuitry 108 can perform incremental count encoding as a variation to the timeframe count encoding of FIG. 3. Instead of doing statistics to the data, the feature organizer circuitry 108 applies a counter to incrementally record the occurrence of features, as shown in connection with FIG. 4. For example, an initial training dataset 405 (N) is obtained at time 0, followed by addition of an example first new dataset 415 at time 1 (N_{newdata1}), which the feature organizer circuitry 108 uses to determine a first count value 420 (e.g., N+N_{newdata1}). Subsequently, at time 2, the feature organizer circuitry 108 obtains a second new dataset 435 (e.g., N_{newdata2}) that can be used to obtain a second count value 440 (e.g., N+N_{newdata1}+N_{newdata2}). As such, the occurrence of features can be incrementally recorded as more data becomes available.

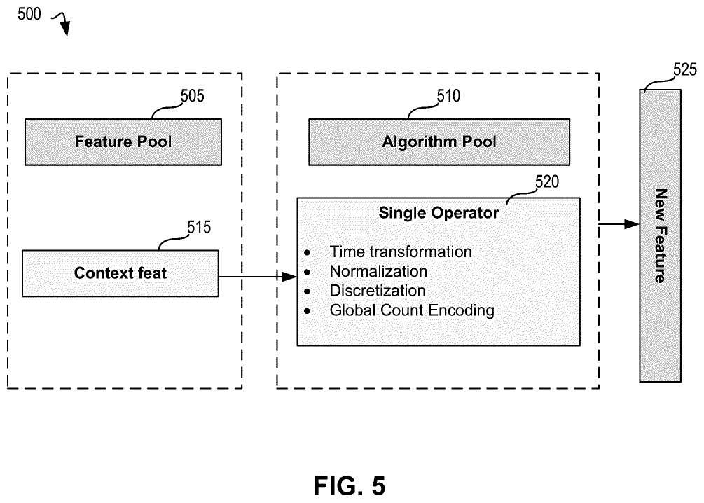

FIG. 5 illustrates an example 500 of context feature generation based on context features. As previously discussed in connection with FIG. 1, context features are individual features used to identify scene context (e.g., time, location, etc.). In examples disclosed herein, the feature organizer circuitry 108 applies time transformation, normalization, discretization and/or global counter encoding for this particular type of feature as part of the feature engineering 120 of FIG. 1. For example, a feature pool 505 represents the set of identified features, where context features 515 are obtained when the feature organizer circuitry 108 classifies the features into one of four classes (e.g., Role 1 features, Role 2 features, context features, and/or interaction features), as described in connection with FIG. 1. An example algorithm pool 510 includes algorithms associated with feature engineering 120 of FIG. 1, including missing value filling with prediction, time feature enhancement, numerical data discretization, etc. In the example of FIG. 5, the context features 515 are processed by the feature organizer circuitry 108 using a single operator technique 520 to obtain an example new feature 525 that is generated using time transformation, normalization, discretization, and/or global count encoding.

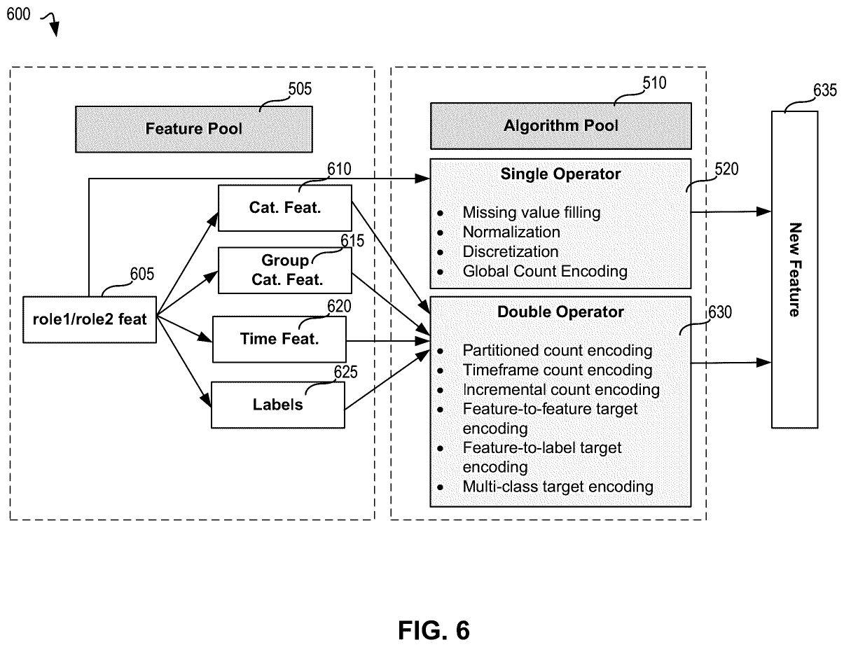

FIG. 6 illustrates an example 600 of feature generation within a same partite. For example, once the features are identified as being associated with a first partite (e.g., Role 1) or a second partite (e.g., Role 2), the feature organizer circuitry 108 divides the features into identifier-based features and attribute-based features. For example, demographic features are typically attribute features, whose distribution is stable across a certain length of time frame (e.g., day, week, month, etc.), such that grouping demographic features together allows for the generation of a cluster center of one partite. In examples disclosed herein, the feature organizer circuitry 108 traverses over all features recursively to detect features and/or combinations of features with the above-described characteristics. Subsequently, the feature organizer circuitry 108 leverages the prior knowledge of different demographic features to generate new features. In some examples, the feature organizer circuitry 108 uses features having less than 5 unique values to perform partitioning. When performing mapping to non-privacy-preserved feature(s), such features (e.g., with less than 5 unique values) are usually gender features. In some examples, features with 5-100 unique values that are not evenly distributed can be assessed using distribution methods, with greater emphasis on the middle interval. When performing mapping to non-privacy-preserved features, such features (e.g., having 5-100 unique values) are age features or major cities. For features having large cardinality and showing new values in upcoming time frame(s), the feature organizer circuitry 108 applies encoding methods and/or time-window incremental encoding methods. When performing mapping to non-privacy-preserved features, such features (e.g., features having large cardinality) In some examples, the feature organizer circuitry 108 transforms attribute features within one partite as a partite identifier. In some examples, the feature organizer circuitry 108 performs group categorization operations to label the attribute feature combinations with a categorical index (e.g., 0, 1, 2, 3, etc.). The various methods used to process different feature classes are shown in connection with FIG. 6. In the example of FIG. 6, the Role 1/Role 2 features (e.g., features 605) are processed using the single operator-based technique 520 described in connection with FIG. 5. The remaining features that are identified from the Role 1/Role 2 features (e.g., categorical features, group categorical features, time features, labels, etc.) are processed using an example double operator-based technique 630. For example, this processing includes partitioned count encoding, timeframe count encoding, incremental count encoding, feature-to-feature target encoding, feature-to-label target encoding, and/or multi-class target encoding. The resulting outputs of the operation(s) 520, 630 result in a new feature 635.

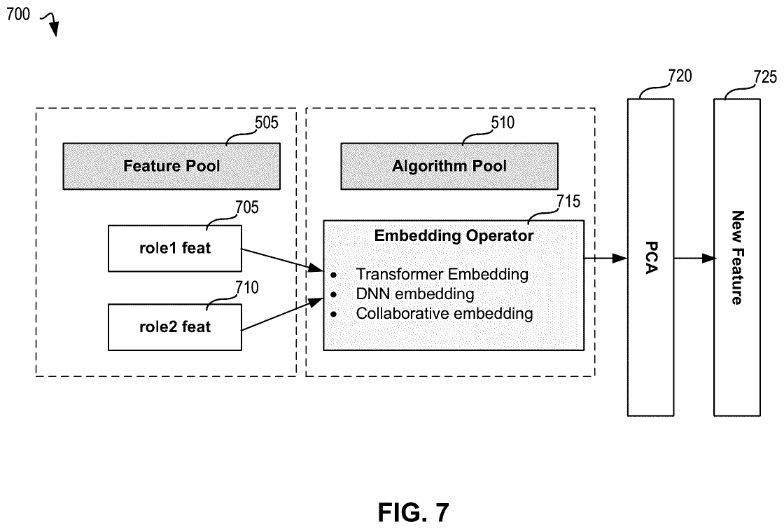

FIG. 7 illustrates an example 700 of feature generation across a partite. For example, as mentioned in connection with FIG. 6, features are identified as being associated with a first partite (e.g., Role 1) or a second partite (e.g., Role 2). For example, after features are grouped within the same partite to create a group identifier, the group identifier can be used as a partite identifier for individual participants in each partite. Individual partite identifiers can then be processed using deep learning-based embedding that relies on identifier features, such as collaborative filtering, bi-partite-based graphing, and/or Multi-gate Mixture-of-Experts (MMoE). As shown in the example of FIG. 7, Role 1 features (e.g., first partite 705) and Role 2 features (e.g., second partite 710) can be fed to an embedding operator 715 for transformed embedding, deep neural network (DNN)-based embedding, and/or collaborative embedding. For example, deep learning methods can be adopted to generate new interaction features between different roles and enhance the final output dataset. In some examples, the feature organizer circuitry 108 uses principal component analysis (PCA) 720 to reduce dimensions when high dimensionalities are identified in the embeddings, resulting in a new feature 725 with embeddings having reduced dimensions.

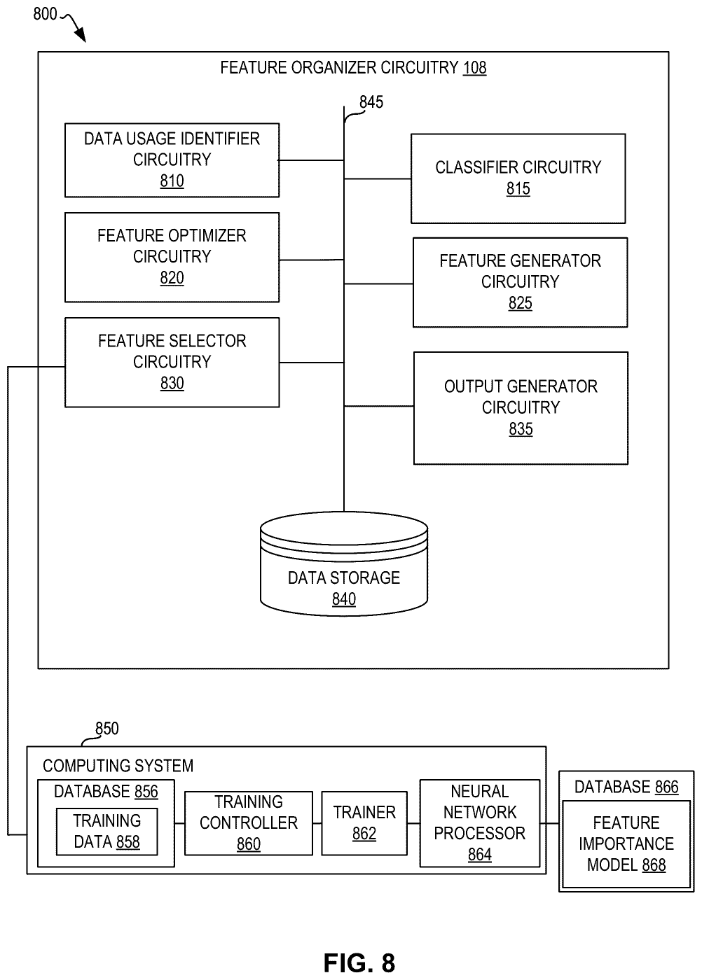

FIG. 8 is a block diagram representative of the feature organizer circuitry 108 that may be implemented in the example environment of FIG. 1. The feature organizer circuitry 108 of FIG. 1 may be instantiated (e.g., creating an instance of, bring into being for any length of time, materialize, implement, etc.) by programmable circuitry such as a Central Processing Unit (CPU) executing first instructions. Additionally or alternatively, the feature organizer circuitry 108 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

In the example of FIG. 8, the feature organizer circuitry 108 includes example data usage identifier circuitry 810, example classifier circuitry 815, example feature optimizer circuitry 820, example feature generator circuitry 825, example feature selector circuitry 830, example output generator circuitry 835, and/or example data storage 840. In the example of FIG. 8, the data usage identifier circuitry 810, classifier circuitry 815, feature optimizer circuitry 820, feature generator circuitry 825, feature selector circuitry 830, output generator circuitry 835, and/or data storage 840 are in communication via an example bus 845.

The data usage identifier circuitry 810 identifies the types of features present in a privacy preserved dataset (e.g., privacy preserved dataset 105 of FIG. 1). For example, the data usage identifier circuitry 810 performs the data type analysis 110 of FIG. 1, including dividing the features into four groups (e.g., specific, categorical, binary, and numerical features). The data usage identifier circuitry 810 identifies features with specific meaning in the privacy preserved dataset 105, since such an anonymous dataset has a subset of data with specific meaning (e.g., identifier (ID), date, geographic coordination, etc.). For example, an identifier serves as a unique identifier for each data point, which enables indexing functionalities. Meanwhile, the date is an important feature identifying the time and sequence of information, while geographic coordination reveals information such as distance and range. The data usage identifier circuitry 810 also identifies categorical features, which are discrete values and are identifiable by determining unique counts of the feature (e.g., mostly integer type or string type features). This data type lends itself well to further refinement through feature engineering methodologies such as count encoding, target encoding, an/or treating the feature as a partition factor for other features, as performed by the feature optimizer circuitry 820. Furthermore, the data usage identifier circuitry 810 identifies binary features that are a specific type of categorical feature (e.g., yes or no answers related to gender, consent, etc.). Separately, numerical features consist of continuous values, which can be integers or floats. To gain deeper insights into these features, the data usage identifier circuitry 810 can compute statistical measures (e.g., minimum, maximum, mean, etc.) thereby obtaining additional statistical information.

The classifier circuitry 815 performs feature classification (e.g., feature classification 115 of FIG. 1) based on the data type analysis. For example, the classifier circuitry 815 applies various distribution analysis approaches on all features to identify features belong to a first partite (e.g., Role 1 features), features belonging to a second partite (e.g., Role 2 features), interaction features between the first partite and the second partite, and individual context features. In recommendation system-based privacy preserved datasets, an assumption can be made that the data is bi-partite, where the first part represents the user or user-like participants and the second part represents the items (e.g., posts, advertisements, products and/or similar concepts). As previously described in connection with FIG. 1, these two parts can be identified as features associated with Role 1 (e.g., first partite) or features associated with Role 2 (e.g., second partite). By classifying the features into four separate classes (e.g., based on partites) using the classifier circuitry 815, the privacy preserved dataset's expressivity and learnability is enriched while preserving the privacy of features (e.g., without decoding, reverse engineering the features).

In examples disclosed herein, the classifier circuitry 815 categorizes features belonging to the same partite. For example, the classifier circuitry 815 uses grouping methods to detect features belonging to each partite. For example, by combining several features, a certain partite is eventually profiled. The classifier circuitry 815 starts with a single feature and uses the feature as a partition key to identify a number of unique values (e.g., nunique) for other features, as described in connection with FIG. 2. The classifier circuitry 815 proceeds to recursively add more features as partition keys and obtain the number of unique values for the remaining features until the feature-based number of unique values remains at one or zero. The classifier circuitry 815 categorizes context features based on whether a feature retains a stable distribution when partitioning with other features or being partitioned with classified partite identifiers. Context features include date, location, and/or other objective contexts where events happen (e.g., such that this feature has no obvious relation to either partite). After the classification of context features and partite-based features, the classifier circuitry 815 treats the remaining features as interaction features (e.g., features connecting partite 1 and partite 2). In some examples, the interaction features have a high correlation to certain partite features but are not grouped with features having a number of unique values of one.

The feature optimizer circuitry 820 performs feature engineering (e.g., feature engineering 120 of FIG. 1) on each class of features (e.g., identified using the classifier circuitry 815) according to their attributes. For example, the feature optimizer circuitry 820 processes categorical features with count encoding and target encoding, interaction features can be further developed by collaborative filtering, and numerical features can be normalized and binned into multiple groups. As such, the feature optimizer circuitry 820 generates many new features resulting from the above processing of the features based on feature class. In examples disclosed herein, the feature optimizer circuitry 820 applies a feature engineering algorithm (e.g., missing value filling with prediction, time feature enhancement, numerical data discretization, etc.). For example, the feature optimizer circuitry 820 can fill missing values in the dataset by training a model with other features and selecting the current feature as a label to fill the missing value based on a generated prediction of the value. Time feature enhancement can be performed by the feature optimizer circuitry 820 by leveraging the analysis of time to convert it to different lengths of a time frame or repeated periods in one time frame (e.g., week, night, etc.). In some examples, other features can be aggregated as part of creating a new feature based on the analysis of existing features. The feature optimizer circuitry 820 performs numerical data discretization to divide numerical data into multiple classes. After discretization, numerical data can be treated as categorical data, allowing for the application of count encoding and/or target encoding to reveal relevant statistical information.

In examples disclosed herein, the feature optimizer circuitry 820 performs record embedding and categorical embedding to exploit potential dimensions of single features and/or single records (e.g., impression). For example, embedding can be used for records (e.g., impressions) as a whole or to treat each categorical feature in the record separately. For example, the feature optimizer circuitry 820 performs record embedding to use hidden layer outputs of either a transformer-based method (e.g., such as TabTransformer, FitTransformer, etc.) or a DNN-based method (e.g., such as DLRM, DCN, MMoE, etc.) to embed a single record as a whole. Furthermore, the feature optimizer circuitry 820 performs categorical embedding to use the embedding outputs of either the transformer-based model or DNN-based model to produce embedding for categorical features. In some examples, the feature optimizer circuitry 820 uses PCA-based methods to reduce dimensions of the embedded outputs after concatenating the embeddings, as described in connection with FIG. 7.

The feature optimizer circuitry 820 further performs enhanced count encoding to enhance count encoding with a second feature or feature set. Count encoding relies on the use of statistical methods to obtain frequencies of occurrences, which is particularly useful when dealing with high-cardinality-based categorical features. In examples disclosed herein, the feature optimizer circuitry 820 resolves high-cardinality-based categorical features with lower-cardinality or with a cold start value. Additional count-based encoding can include partitioned count encoding, timeframe count encoding, and incremental count encoding. Partitioned count encoding is used to obtain small cardinality features as partitioning keys for other features within the same class, followed by count encoding. Timeframe count encoding uses time information in some time-sensitive situations, where count values based on all data may not be as useful as the latest data, as described in connection with FIG. 3. Incremental count encoding is a variation of timeframe count encoding. Instead of obtaining statistics on the data, the feature optimizer circuitry 820 uses a counter to perform recording of the occurrence of features in increments, as described in connection with FIG. 4.

As part of feature engineering, the feature optimizer circuitry 820 performs target encoding to obtain frequencies of occurrences based on a target label, which is particularly useful for a cold start value. In examples disclosed herein, target encoding is extended to multi-class target estimation and used for predicting other feature probability instead of target probability. For example, assuming a training dataset with a sample size of n, denoted as {((X₁, Y₁), . . . , (Xᵢ,Yᵢ), . . . , (Xₙ, Yₙ)}), containing a binary target variable Yᵢ∈{0,1} and a high-cardinality categorical variable with k categories Xᵢ∈{C₁, . . . , Cⱼ, . . . , Cₖ}, the feature optimizer circuitry 820 determines the target encoding of Cⱼ using Equation 1, as shown below:

$$P ( Y = 1 \vert X = {C}_{j} ) = \frac{N ( X = {C}_{j} Λ Y = 1 )}{N ( X = {C}_{j} )} \qquad ( 1 )$$

In the example of Equation 1, N(X=Cⱼ) is the sample number when X=Cⱼ and N(X=Cⱼ∧Y=1) is the sample num when X=Cⱼ and Y=1. For example, Y refers to regular binary feature(s) or another training objective (e.g., when formulating a multi-task problem where other training objectives are relevant to the original training objective).

Furthermore, the feature optimizer circuitry 820 performs multi-class target encoding using a one-hot encoding (e.g., performed on the multi-class variable before target encoding). For example, if the original feature has k values, the feature optimizer circuitry 820 encodes this feature into k−1 binarized features. Subsequently, the feature optimizer circuitry 820 performs target encoding of k−1 binarized features to encode high-cardinality categorical features. In some examples, the feature optimizer circuitry 820 also performs interaction features embedding to leverage the previously classified two feature partites (e.g., Role 1 features, Role 2 features) to formulate interactions between the different partite(s). For example, the feature optimizer circuitry 820 uses a collaborative filtering (CF) method to perform similarity calculations for features with the same partite, identifying preferences (e.g., interests) of the partite(s) and generating embeddings for features belonging to each partite. Concatenated embeddings can then be used as features of the final models.

The feature generator circuitry 825 applies feature generation methods using context feature transformation. For example, the feature generator circuitry 825 performs feature generation within the same partite and feature generation across partite(s), as illustrated in connection with FIGS. 6-7. As previously described, the features belonging to a first partite and a second partite can be divided into identifier features and attribute features. For example, demographic features are typical attribute features, whose distribution is stable across a certain length of a timeframe. In examples disclosed herein, the feature generator circuitry 825 traverses over all the features recursively to detect features and combinations of features with the above-described characteristics. For example, the feature generator circuitry 825 can apply distribution methods on features with 5-100 unique values (e.g., without even distribution) and encoding or time-window increment encoding methods to features showing large cardinality (e.g., showing new values in upcoming time frame(s)). For feature generation across partite(s), the feature generator circuitry 825 performs interaction between features associated with different partite(s). After the grouping of features within the same partite to create a group identifier, the partite identifier can be treated as the same identifier for individual participants in each partite. The feature generator circuitry 825 feeds the individual Partite identifiers into deep learning embedding-based methods that rely on identifiers (e.g., using collaborative filtering, etc.).

The feature selector circuitry 830 performs feature selection (e.g., feature selection 130 of FIG. 1) to identify the most important features to generate a feature-enhanced dataset for model training and acquiring a precise understanding of the true significance of each feature. Given the numerous features generated using the feature optimizer circuitry 820 and the feature generator circuitry 825, the additional features can make the model prone to overfitting while increasing computational overhead associated with a higher data storage cost. As such, the feature selector circuitry 830 selects the most important features using a backward elimination method, which iteratively removes the least important features based on their importance scores. For example, the feature selector circuitry 830 trains a gradient boosted decision tree-based (GBDT) model to determine feature performance. For example, the feature importance algorithm used by GBDT is based on an average impurity reduction or gain across all trees in the ensemble. However, other feature methods can be used by the feature selector circuitry 830, including Shapley Values and/or LIME (e.g., Local Interpretable Model-Agnostic Explanations), to extract feature importance. The feature selector circuitry 830 identifies the features with the lowest importance scores based on the trained model and removes them from the feature set. The remaining features, which are considered more important, are then used to train a new GBDT model. The feature selector circuitry 830 repeats the training process until the number of remaining features (1) reaches a desired or predefined size (e.g., a predefined feature size threshold is reached), (2) the importance score of a feature falls below the target threshold, or (3) a significant model performance regression is observed.

As illustrated in FIG. 8, the feature selector circuitry 830 is in communication with a computing system 850 that trains a neural network to generate an example feature importance model 868. For example, as described above, the feature selector circuitry 830 generates model(s) of feature importance. In examples disclosed herein, the training data used for training during model generation originates from observed importance of features for recommendation systems. As previously described, feature importance models are generated using a feature importance algorithm based on GBDT to determine average impurity reduction or gain across all trees in the ensemble, thereby identifying features that are of higher and lower importance. In some examples, the training data is labeled. In some examples, the training data is sub-divided such that a portion of the data is used for validation purposes.

Once training is complete, the feature importance model(s) are stored in one or more databases (e.g., database 866 of FIG. 8). One or more of the models may then be executed by, for example, the feature selector circuitry 830. Once trained, the deployed model(s) may be operated in an inference phase to process data. In the inference phase, data to be analyzed (e.g., live data) is input to the model, and the model executes to create an output. Moreover, in some examples, the output data may undergo post-processing after it is generated by the AI model to transform the output into a useful result (e.g., a display of data, an instruction to be executed by a machine, etc.). In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 8, the computing system 850 trains a neural network to generate the feature importance model 868. The example computing system 850 includes a neural network processor 864. In examples disclosed herein, the neural network processor 864 implements a neural network. The computing system 850 of FIG. 8 also includes a neural network trainer 862. The neural network trainer 862 of FIG. 8 performs training of the neural network implemented by the neural network processor 864.

The computing system 850 of FIG. 8 includes a training controller 860. The training controller 860 instructs the neural network trainer 862 to perform training of the neural network based on training data 858. In the example of FIG. 8, the training data 858 used by the neural network trainer 862 to train the neural network is stored in a database 856. The example database 856 of the illustrated example of FIG. 8 is implemented by any memory, storage device and/or storage disc for storing data such as, for example, flash memory, magnetic media, optical media, etc. Furthermore, the data stored in the example database 856 may be in any data format such as, for example, binary data, comma delimited data, tab delimited data, structured query language (SQL) structures, image data, etc. While the illustrated example database 856 is illustrated as a single element, the database 856 and/or any other data storage elements described herein may be implemented by any number and/or type(s) of memories. The neural network trainer 862 trains the neural network implemented by the neural network processor 864 using the training data 858 to generate the feature importance model 868 as a result of the neural network training The feature importance model 868 is stored in a database 866. The databases 856, 866 may be the same storage device or different storage devices.

The output generator circuitry 835 trains a machine learning model with all the selected features identified using the feature selector circuitry 830. For example, the backward elimination method used by the feature selector circuitry 830 stands out from common feature reduction processes due to this method's iterative elimination based on feature importance and integration with GBDT, providing a robust and data-driven approach to identify redundant features. Additionally, the iterative evaluation of model performance enhances the method's effectiveness in producing a compact, yet informative, feature set, thereby boosting the prediction accuracy. The output generator circuitry 835 uses the selected features to output a final trained model that can be used by a recommendation system based on the available privacy preserved dataset(s).

The data storage 840 can be used to store any information associated with the data usage identifier circuitry 810, classifier circuitry 815, feature optimizer circuitry 820, feature generator circuitry 825, feature selector circuitry 830, output generator circuitry 835, and/or data storage 840. The data storage 840 of the illustrated example of FIG. 8 can be implemented by any memory, storage device and/or storage disc for storing data such as flash memory, magnetic media, optical media, etc. Furthermore, the data stored in the example data storage 840 can be in any data format such as binary data, comma delimited data, tab delimited data, structured query language (SQL) structures, image data, etc.

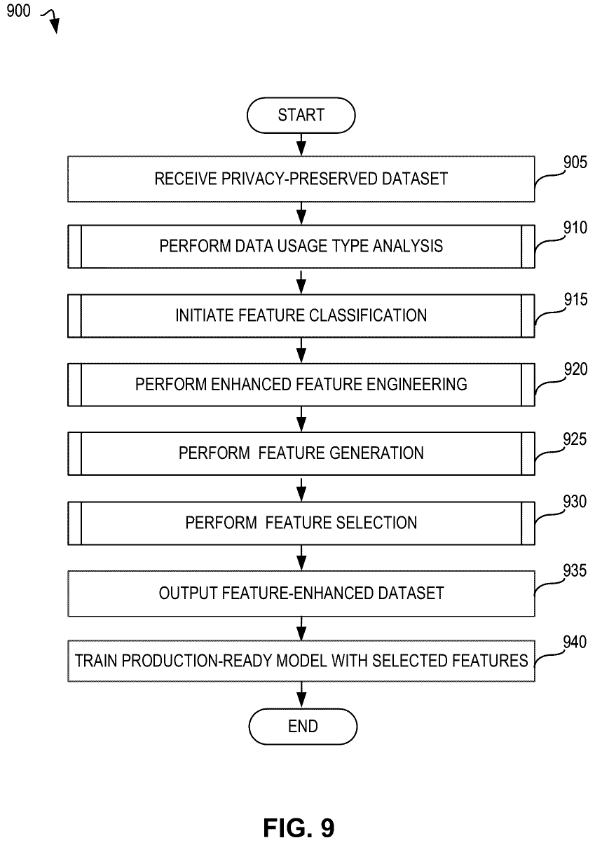

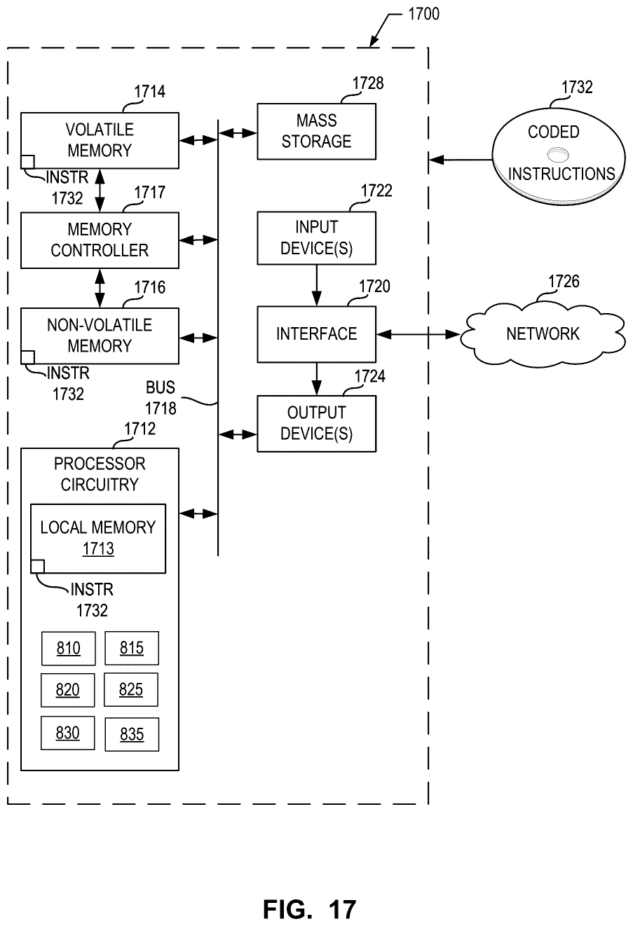

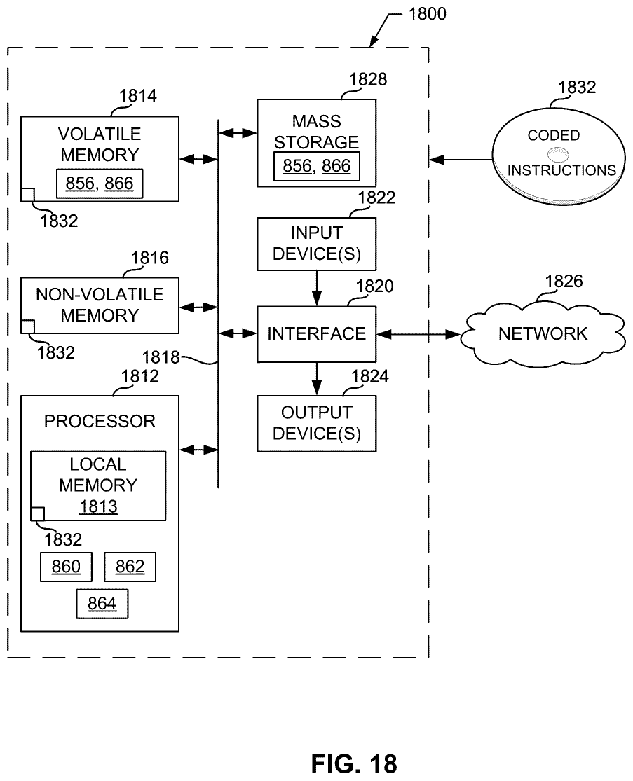

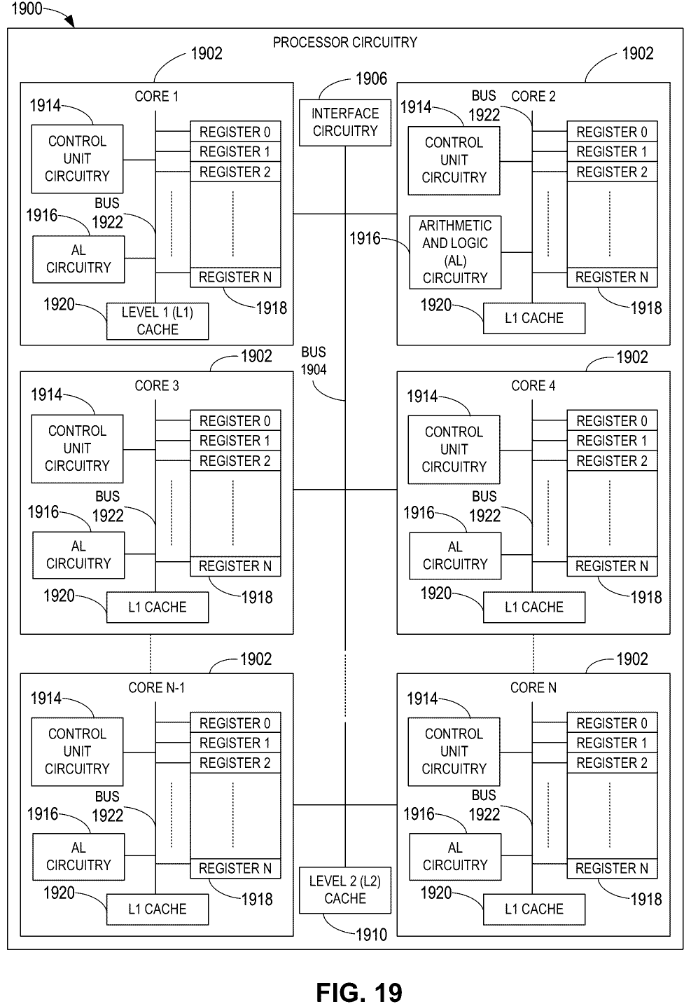

In some examples, the apparatus includes means for identifying data usage. For example, the means for identifying data usage may be implemented by data usage identifier circuitry 810. In some examples, the data usage identifier circuitry 810 may be instantiated by programmable circuitry such as the example programmable circuitry 1712 of FIG. 17. For instance, the data usage identifier circuitry 810 may be instantiated by the example microprocessor 1800 of FIG. 18 executing machine executable instructions such as those implemented by at least block 910 of FIG. 9. In some examples, the data usage identifier circuitry 810 may be instantiated by hardware logic circuitry, which may be implemented by an ASIC, XPU, or the FPGA circuitry 1900 of FIG. 19 structured to perform operations corresponding to the machine readable instructions. Additionally or alternatively, the data usage identifier circuitry 810 may be instantiated by any other combination of hardware, software, and/or firmware. For example, the data usage identifier circuitry 810 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for classifying. For example, the means for classifying may be implemented by classifier circuitry 815. In some examples, the classifier circuitry 815 may be instantiated by programmable circuitry such as the example programmable circuitry 1712 of FIG. 17. For instance, the classifier circuitry 815 may be instantiated by the example microprocessor 1800 of FIG. 18 executing machine executable instructions such as those implemented by at least block 915 of FIG. 9. In some examples, the classifier circuitry 815 may be instantiated by hardware logic circuitry, which may be implemented by an ASIC, XPU, or the FPGA circuitry 1900 of FIG. 19 structured to perform operations corresponding to the machine readable instructions. Additionally or alternatively, the classifier circuitry 815 may be instantiated by any other combination of hardware, software, and/or firmware. For example, the classifier circuitry 815 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for optimizing features. For example, the means for optimizing features may be implemented by feature optimizer circuitry 820. In some examples, the feature optimizer circuitry 820 may be instantiated by programmable circuitry such as the example programmable circuitry 1712 of FIG. 17. For instance, the feature optimizer circuitry 820 may be instantiated by the example microprocessor 1800 of FIG. 18 executing machine executable instructions such as those implemented by at least block 920 of FIG. 9. In some examples, the feature optimizer circuitry 820 may be instantiated by hardware logic circuitry, which may be implemented by an ASIC, XPU, or the FPGA circuitry 1900 of FIG. 19 structured to perform operations corresponding to the machine readable instructions. Additionally or alternatively, the feature optimizer circuitry 820 may be instantiated by any other combination of hardware, software, and/or firmware. For example, the feature optimizer circuitry 820 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating features. For example, the means for generating features may be implemented by feature generator circuitry 825. In some examples, the feature generator circuitry 825 may be instantiated by programmable circuitry such as the example programmable circuitry 1712 of FIG. 17. For instance, the feature generator circuitry 825 may be instantiated by the example microprocessor 1800 of FIG. 18 executing machine executable instructions such as those implemented by at least block 925 of FIG. 9. In some examples, the feature generator circuitry 825 may be instantiated by hardware logic circuitry, which may be implemented by an ASIC, XPU, or the FPGA circuitry 1900 of FIG. 19 structured to perform operations corresponding to the machine readable instructions. Additionally or alternatively, feature generator circuitry 825 may be instantiated by any other combination of hardware, software, and/or firmware. For example, the feature generator circuitry 825 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for selecting features. For example, the means for selecting features may be implemented by feature selector circuitry 830. In some examples, the feature selector circuitry 830 may be instantiated by programmable circuitry such as the example programmable circuitry 1712 of FIG. 17. For instance, the feature selector circuitry 830 may be instantiated by the example microprocessor 1800 of FIG. 18 executing machine executable instructions such as those implemented by at least block 930 of FIG. 9. In some examples, the feature selector circuitry 830 may be instantiated by hardware logic circuitry, which may be implemented by an ASIC, XPU, or the FPGA circuitry 1900 of FIG. 19 structured to perform operations corresponding to the machine readable instructions. Additionally or alternatively, feature selector circuitry 830 may be instantiated by any other combination of hardware, software, and/or firmware. For example, the feature selector circuitry 830 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for outputting features. For example, the means for outputting features may be implemented by output generator circuitry 835. In some examples, the output generator circuitry 835 may be instantiated by programmable circuitry such as the example programmable circuitry 1712 of FIG. 17. For instance, the output generator circuitry 835 may be instantiated by the example microprocessor 1800 of FIG. 18 executing machine executable instructions such as those implemented by at least block 935 of FIG. 9. In some examples, the output generator circuitry 835 may be instantiated by hardware logic circuitry, which may be implemented by an ASIC, XPU, or the FPGA circuitry 1900 of FIG. 19 structured to perform operations corresponding to the machine readable instructions. Additionally or alternatively, output generator circuitry 835 may be instantiated by any other combination of hardware, software, and/or firmware. For example, the output generator circuitry 835 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the feature organizer circuitry 108 of FIG. 1 is illustrated in FIG. 8, one or more of the elements, processes and/or devices illustrated in FIG. 8 may be combined, divided, re-arranged, omitted, eliminated and/or implemented in any other way. Further, the example data usage identifier circuitry 810, the example classifier circuitry 815, the example feature optimizer circuitry 820, the example feature generator circuitry 825, the example feature selector circuitry 830, the example output generator circuitry 835, and/or, more generally, the example feature organizer circuitry 108 of FIG. 1 may be implemented by hardware, software, firmware and/or any combination of hardware, software and/or firmware. Thus, for example, any of the example data usage identifier circuitry 810, the example classifier circuitry 815, the example feature optimizer circuitry 820, the example feature generator circuitry 825, the example feature selector circuitry 830, the example output generator circuitry 835, and/or, more generally, the example feature organizer circuitry 108 of FIG. 1 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the feature organizer circuitry 108 of FIG. 1 may include one or more elements, processes, and/or devices in addition to, or instead of, those illustrated in FIG. 8, and/or may include more than one of any or all of the illustrated elements, processes and devices.

Flowcharts representative of example machine readable instructions, which may be executed by programmable circuitry to implement and/or instantiate the feature organizer circuitry 108 of FIG. 1 and/or representative of example operations which may be performed by programmable circuitry to implement and/or instantiate the feature organizer circuitry 108 of FIG. 1, are shown in FIGS. 9-15. The machine readable instructions may be one or more executable programs or portion(s) of one or more executable programs for execution by programmable circuitry, such as the programmable circuitry 1712 shown in the example processor platform 1700 discussed below in connection with FIG. 17 and/or may be one or more function(s) or portion(s) of functions to be performed by the example programmable circuitry (e.g., an FPGA) discussed below in connection with FIGS. 18 and/or 19. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 9-15, many other methods of implementing the example feature organizer circuitry 108 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9-15 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, and/or activities, the phrase “at least one of A and B” is intended to refer to implementations including any of (1) at least one A, (2) at least one B, or (3) at least one A and at least one B. Similarly, as used herein in the context of describing the performance or execution of processes, instructions, actions, and/or activities, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions and/or example operations 900 that may be executed, instantiated, and/or performed by programmable circuitry to implement the example feature organizer circuitry 108 of FIG. 1. The machine readable instructions and/or the operations 900 of FIG. 9 begin at block 905, at which the data usage identifier circuitry 810 of FIG. 8 receives a privacy-preserved dataset (e.g., privacy-preserved dataset 105 of FIG. 1). The data usage identifier circuitry 810 performs data usage type analysis based on the received privacy-preserved dataset, at block 910. For example, the data usage identifier circuitry 810 identifies features with specific meaning, categorical features, binary features, and/or numerical features, as described in more detail in connection with FIG. 10. Once the data usage type(s) are identified and/or if the data usage types are known, the classifier circuitry 815 performs feature classification, at block 915. For example, the classifier circuitry 815 identifies feature classes, detects features belonging to a first partite and/or a second partite, identifies context features, and identifies interaction features, as described in more detail in connection with FIG. 11. Subsequently, the feature optimizer circuitry 820 performs enhanced feature engineering using the classified features, at block 920. For example, the feature optimizer circuitry 820 performs feature engineering tasks such as time feature enhancement, numerical data discretization, categorical embedding, and count encoding, among others, as described in more detail in connection with FIG. 12. The feature generator circuitry 825 proceeds to perform feature generation once feature engineering is completed using the feature optimizer circuitry 820, at block 925. For example, the feature generator circuitry 825 applies context feature transformation and performs feature generation within the same partite and across partite(s), as described in more detail in connection with FIG. 13. Once the features are generated, the feature selector circuitry 830 performs feature selection, at block 930. For example, the feature selector circuitry 830 determines feature importance using a gradient boosted decision tree-based (GBDT) model, as described in more detail in connection with FIG. 14. Once feature importance is extracted, the output generator circuitry 835 outputs the feature-enhanced dataset, at block 935. Subsequently, the output generator circuitry 835 can be used to train a machine learning model with the selected features, at block 940.

FIG. 10 is a flowchart representative of example machine readable instructions and/or example operations 910 that may be executed, instantiated, and/or performed by programmable circuitry to implement the example feature organizer circuitry 108 of FIG. 1 to perform data usage type analysis. The machine readable instructions and/or the operations 910 of FIG. 10 begin at block 1005, at which the data usage identifier circuitry 810 performs data usage type analysis by identifying features with specific meaning (e.g., data identifiers), at block 1005. For example, the specific features have specific meaning in the privacy preserved dataset 105 of FIG. 1, since such an anonymous dataset has a subset of data with specific meaning (e.g., identifier (ID), date, geographic coordination, etc.). The data usage identifier circuitry 810 also identifies categorical features (e.g., integer type, string type), at block 1010. Categorical features are discrete values and are identifiable by determining unique counts of the feature. Furthermore, the data usage identifier circuitry 810 identifies binary features, at block 1015, and numerical features, at block 1020. Binary features are a specific type of categorical feature (e.g., yes/no answers), while numerical features consist of continuous values (e.g., integers, floats), as shown in connection with FIG. 1.

FIG. 11 is a flowchart representative of example machine readable instructions and/or example operations 915 that may be executed, instantiated, and/or performed by programmable circuitry to implement the example feature organizer circuitry 108 of FIG. 1 to initiate anonymous feature classification. The machine readable instructions and/or the operations 915 of FIG. 11 begin at block 1105, at which the classifier circuitry 815 performs feature classification. In the example of FIG. 11, the classifier circuitry 815 identifies feature classes that the privacy-preserved dataset features can be classified into (e.g., features belong to a first partite (e.g., Role 1 features), features belonging to a second partite (e.g., Role 2 features), interaction features between the first partite and the second partite, and individual context features.). The classifier circuitry 815 uses a grouping method to detect features belonging to the first partite and the second partite, at block 1110. For example, the classifier circuitry 815 identifies the input data as bi-partite data, where the first part represents the user or user-like participants and the second part represents the items (e.g., posts, advertisements, etc.). As such, the classifier circuitry 815 identifies bi-partite features as features associated with Role 1 (e.g., first partite) or features associated with Role 2 (e.g., second partite), as shown in connection with FIG. 1. The classifier circuitry 815 also identifies context features (e.g., date, location), at block 1115, based on whether a feature retains a stable distribution when partitioning with other features or being partitioned with classified partite identifiers. The classifier circuitry 815 treats the remaining features as interaction features (e.g., features connecting partite 1 and partite 2). The classifier circuitry 815 identifies these interaction features at block 1120.

FIG. 12 is a flowchart representative of example machine readable instructions and/or example operations 920 that may be executed, instantiated, and/or performed by programmable circuitry to implement the example feature organizer circuitry 108 of FIG. 1 to perform enhanced feature engineering. The machine readable instructions and/or the operations 920 of FIG. 12 begin at block 1205, at which the feature optimizer circuitry 820 fills missing values with prediction(s). For example, the feature optimizer circuitry 820 performs feature engineering on each class of features according to their attributes. In some examples, the feature optimizer circuitry 820 fills missing values in the dataset by training a model with other features and selecting the current feature as a label to fill the missing value based on a generated prediction of the value. The feature optimizer circuitry 820 performs feature enhancement, at block 1210, by focusing on time-based anlaysis of the features. The feature optimizer circuitry 820 also performs numerical data discretization, at block 1215, by dividing numerical data into multiple classes. After discretization, the feature optimizer circuitry 820 treats the numerical data as categorical data, allowing for the application of count encoding and/or target encoding to reveal relevant statistical information. For example, the feature optimizer circuitry 820 initiates record embedding and/or categorical embedding, at block 1220. For example, the feature optimizer circuitry 820 performs record embedding and categorical embedding to exploit potential dimensions of single features and/or single records (e.g., impressions). The feature optimizer circuitry 820 performs categorical embedding to use the embedding outputs of either a transformer-based model or a DNN-based model to produce embedding for categorical features, as described in connection with FIG. 8. In some examples, the feature optimizer circuitry 820 uses PCA-based methods to reduce dimensions of the embedded outputs after concatenating the embeddings. In some examples, the feature optimizer circuitry 820 performs enhanced count encoding to enhance count encoding with a second feature or feature set, at block 1225. Count encoding relies on the use of statistical methods to obtain frequencies of occurrences, which is relevant for high-cardinality-based categorical features, as described in more detail in connection with FIG. 8. The feature optimizer circuitry 820 can also perform additional count-based encoding (e.g., partitioned count encoding, timeframe count encoding, and incremental count encoding). As part of feature engineering, the feature optimizer circuitry 820 also performs target encoding (e.g., using feature-to-feature target encoding) and/or multi-class target encoding, at block 1230. For example, the feature optimizer circuitry 820 performs target encoding to obtain frequencies of occurrences based on a target label. The feature optimizer circuitry 820 performs multi-class target encoding using a one-hot encoding (e.g., performed on a multi-class variable before target encoding), as further described in connection with FIG. 8. Once the encodings are completed, the feature optimizer circuitry 820 embeds interaction features and uses concatenated embeddings as feature inputs to the feature generator circuitry 825.

FIG. 13 is a flowchart representative of example machine readable instructions and/or example operations 925 that may be executed, instantiated, and/or performed by programmable circuitry to implement the example feature organizer circuitry 108 of FIG. 1 to perform feature generation. The machine readable instructions and/or the operations 925 of FIG. 13 begin at block 1305, at which the feature generator circuitry 825 performs context feature transformation based on feature generation within the same partite and feature generation across partite(s), as described in connection with FIGS. 6-7. For example, the feature generator circuitry 825 determines whether to perform feature generation within the same partite, at block 1310. To perform feature generation within the same partite, the feature generator circuitry 825 traverses all features recursively to detect feature(s) and/or feature combinations based on feature characteristics (e.g., attribute features, identifier features, etc.), at block 1315. As previously described, the feature generator circuitry 825 applies distribution methods on features with 5-100 unique values and encoding or time-window increment encoding methods on features showing large cardinality. In the presence of multiple partite(s), the feature generator circuitry 825 determines whether to perform feature generation across partite(s), at block 1320. For example, the feature generator circuitry 825 performs feature generation across partite(s) through identified interactions between features associated with the different partite(s). For example, after the grouping of features within the same partite to create a group identifier, the partite identifier can be treated as the same identifier for individual participants in each partite. The feature generator circuitry 825 feeds the individual partite identifiers into a deep learning embedding-based model (e.g., using collaborative filtering), at block 1325.

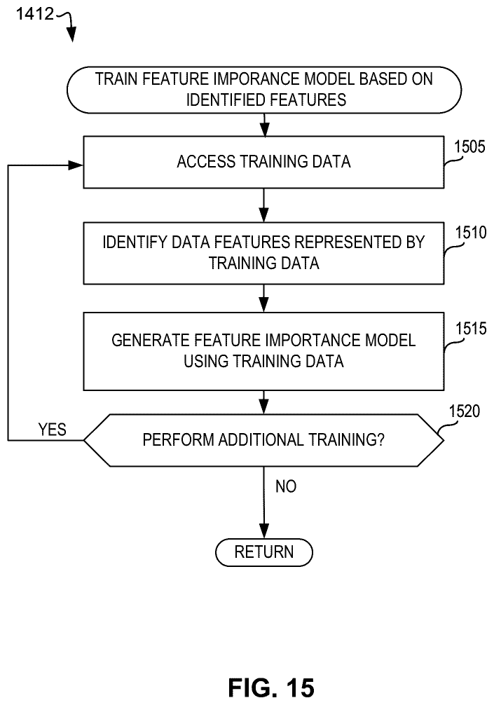

FIG. 14 is a flowchart representative of example machine readable instructions and/or example operations 930 that may be executed, instantiated, and/or performed by programmable circuitry to implement the example feature organizer circuitry 108 of FIG. 1 to perform feature selection. The machine readable instructions and/or the operations 930 of FIG. 14 begin at block 1410, at which the feature selector circuitry 830 identifies features with the lowest importance scores and removes them from the feature set. For example, once feature generation is completed, the feature selector circuitry 830 reduces the total number of features to features that are most important based on a backward elimination method, which iteratively removes the least important features based on their importance scores. The feature selector circuitry 830 inputs the selected features into a deep learning-based model to determine feature performance. In examples disclosed herein, the feature selector circuitry 830 performs feature importance identification using a gradient boosted decision tree-based (GBDT) model. The feature selector circuitry 830 initiates training of the GBDT model using the computing system 850 of FIG. 8, at block 1412, as described in more detail in connection with FIG. 15. The feature selector circuitry 830 continues to train the feature importance model until the number of remaining features reaches a predefined feature size threshold, the importance score of a feature falls below the target threshold, or significant model performance regression is observed, at block 1420. The feature selector circuitry 830 outputs the resulting selected features based on their determined importance, at block 1425.

FIG. 15 is a flowchart representative of example machine readable instructions and/or example operations 1412 that may be executed, instantiated, and/or performed by programmable circuitry to implement the example feature organizer circuitry 108 of FIG. 1 to perform feature importance model training The machine readable instructions and/or the operations 1412 of FIG. 15 begin at block 1505, at which the feature organizer circuitry 108 accesses training data 858. The training data 858 can include results from feature importance training, such as which features can be used for effective assessments as part of a recommendation system. In some examples, the training data is labeled. In some examples, the training data is sub-divided such that a portion of the data is used for validation purposes. The trainer 862 identifies data features represented by the training data 858, at block 1510. In some examples, the training controller 860 instructs the trainer 862 to perform training of the neural network using the training data 858 to generate the feature importance model 868, at block 1515. In some examples, additional training is performed to refine the feature importance model 868, at block 1520.

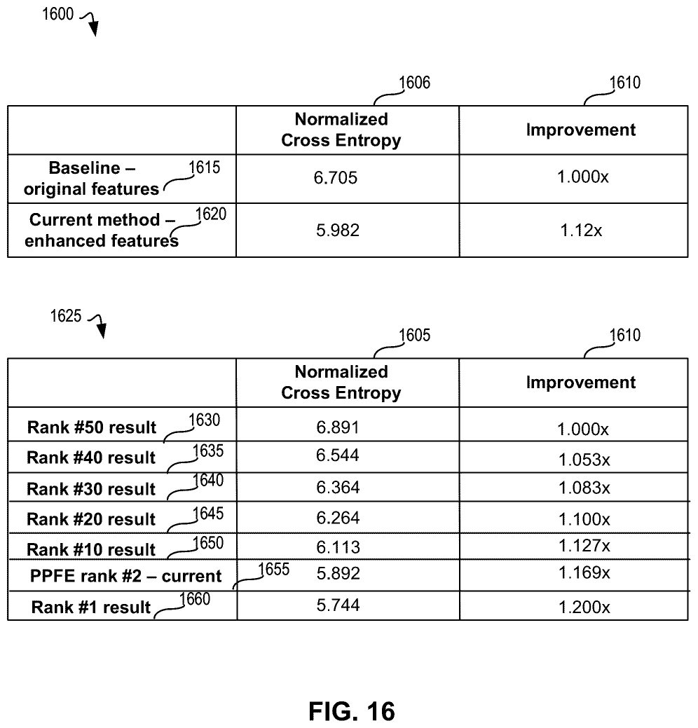

FIG. 16 is an example of score comparison charts 1600, 1625 showing normalized cross entropy and corresponding improvements in user privacy. In the example of FIG. 16, baseline (original features) 1615 and the method disclosed herein (enhanced features) 1620 are compared based on normalized cross entropy (NCE) values 1606 and overall improvement observation 1610. For example, testing of the datasets can be used to assist recommendation systems associated with online advertising while maintaining user privacy. All features provided in the initial input datasets are processed by the privacy-preserving method disclosed herein. A lowed normalized cross entropy score indicates improved accuracy using the datasets (e.g., dataset with original features versus dataset with enhanced features as generated using methods and apparatus disclosed herein). In the example of FIG. 16, the baseline input data is trained on original features with the same training methodology and hyper-parameters, resulting in an NCE score of 6.705. Using methods disclosed herein, the use of the enhanced features results in an NCE score of 5.892, showing a 12% improvement in accuracy. A further assessment of the results is shown in connection with the score comparison chart 1625, where various rank results (e.g., rank results 1630, 1635, 1640, 1654, 1650, 1660) are compared with the outputs identified using methods and apparatus disclosed herein (e.g., second ranked method 1655).

FIG. 17 is a block diagram of an example programmable circuitry platform 1700 structured to execute and/or instantiate the example machine-readable instructions and/or the example operations of FIGS. 9-15 to implement the example feature organizer circuitry 108. The programmable circuitry platform 1700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1700 of the illustrated example includes programmable circuitry 1712. The programmable circuitry 1712 of the illustrated example is hardware. For example, the programmable circuitry 1712 can be implemented by one or more integrated circuits, logic circuits, FPGAs microprocessors, CPUs, GPUs, DSPs, and/or microcontrollers from any desired family or manufacturer. The programmable circuitry 1712 may be implemented by one or more semiconductor based (e.g., silicon based) devices. In this example, the processor circuitry 1712 implements the data usage identifier circuitry 810, the classifier circuitry 815, the feature optimizer circuitry 820, the feature generator circuitry 825, the feature selector circuitry 830, and the output generator circuitry 835.

The programmable circuitry 1712 of the illustrated example includes a local memory 1713 (e.g., a cache, registers, etc.). The programmable circuitry 1712 of the illustrated example is in communication with a main memory including a volatile memory 1714 and a non-volatile memory 1716 by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717. In some examples, the memory controller 1717 may be implemented by one or more integrated circuits, logic circuits, microcontrollers from any desired family or manufacturer, or any other type of circuitry to manage the flow of data going to and from the main memory 1714, 1716.

The programmable circuitry platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1722 are connected to the interface circuitry 1720. The input device(s) 1722 permit(s) a user (e.g., a human user, a machine user, etc.) to enter data and/or commands into the programmable circuitry 1712. The input device(s) 1722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1724 are also connected to the interface circuitry 1720 of the illustrated example. The output devices 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1700 of the illustrated example also includes one or more mass storage devices 1728 to store software and/or data. Examples of such mass storage devices 1728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1732, which may be implemented by the machine readable instructions of FIGS. 9-15, may be stored in the mass storage device 1728, in the volatile memory 1714, in the non-volatile memory 1716, and/or on at least one non-transitory computer readable storage medium such as a CD or DVD which may be removable.

FIG. 18 is a block diagram of an example programmable circuitry platform 1800 structured to execute and/or instantiate the example machine-readable instructions and/or the example operations of FIG. 15 to implement the example computing system 850 of FIG. 8. The programmable circuitry platform 1800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1800 of the illustrated example includes programmable circuitry 1812. The programmable circuitry 1812 of the illustrated example is hardware. For example, the programmable circuitry 1812 can be implemented by one or more integrated circuits, logic circuits, FPGAs microprocessors, CPUs, GPUs, DSPs, and/or microcontrollers from any desired family or manufacturer. The programmable circuitry 1812 may be implemented by one or more semiconductor based (e.g., silicon based) devices. In this example, the programmable circuitry 1812 implements the example neural network processor 864, the example trainer 862, and the example training controller 860.

The programmable circuitry 1812 of the illustrated example includes a local memory 1813 (e.g., a cache, registers, etc.). The programmable circuitry 1812 of the illustrated example is in communication with a main memory including a volatile memory 1814 and a non-volatile memory 1816 by a bus 1818. The volatile memory 1814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1816 may be implemented by flash memory and/or any other desired type of memory device. Access to the main memory 1814, 1816 of the illustrated example is controlled by a memory controller 1817. In some examples, the memory controller 1817 may be implemented by one or more integrated circuits, logic circuits, microcontrollers from any desired family or manufacturer, or any other type of circuitry to manage the flow of data going to and from the main memory 1814, 1816.

The programmable circuitry platform 1800 of the illustrated example also includes interface circuitry 1820. The interface circuitry 1820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1822 are connected to the interface circuitry 1820. The input device(s) 1822 permit(s) a user (e.g., a human user, a machine user, etc.) to enter data and/or commands into the programmable circuitry 1812. The input device(s) 1822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1824 are also connected to the interface circuitry 1820 of the illustrated example. The output devices 1824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1800 of the illustrated example also includes one or more mass storage devices 1828 to store software and/or data. Examples of such mass storage devices 1828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1832, which may be implemented by the machine readable instructions of FIG. 15, may be stored in the mass storage device 1828, in the volatile memory 1814, in the non-volatile memory 1816, and/or on at least one non-transitory computer readable storage medium such as a CD or DVD which may be removable.

FIG. 19 is a block diagram of an example implementation of the programmable circuitry 1712, 1812 of FIGS. 17, 18. In this example, the programmable circuitry 1712, 1812 of FIGS. 17-18 is implemented by a microprocessor 1900. For example, the microprocessor 1900 may be a general purpose microprocessor (e.g., general purpose microprocessor circuitry). The microprocessor 1900 executes some or all of the machine readable instructions of the flowchart of FIGS. 9-15 to effectively instantiate the circuitry of FIG. 8 logic circuits to perform the operations corresponding to those machine readable instructions. In some such examples, the circuitry of FIG. 8 is instantiated by the hardware circuits of the microprocessor 1900 in combination with the instructions. For example, the microprocessor 1900 may implement multi-core hardware circuitry such as a CPU, a DSP, a GPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine readable instructions and/or operations represented by the flowcharts of FIGS. 9-15.

The cores 1902 may communicate by a first example bus 1904. In some examples, the first bus 1904 may implement a communication bus to effectuate communication associated with one(s) of the cores 1902. For example, the first bus 1904 may implement at least one of an Inter-Integrated Circuit (I2C) bus, a Serial Peripheral Interface (SPI) bus, a PCI bus, or a PCIe bus. Additionally or alternatively, the first bus 1904 may implement any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2_cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1914, 1916 of FIG. 19). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the L1 cache 1920, and a second example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer-based operations. In other examples, the AL circuitry 1916 also performs floating-point operations. In yet other examples, the AL circuitry 1916 may include first AL circuitry that performs integer-based operations and second AL circuitry that performs floating point operations. In some examples, the AL circuitry 1916 may be referred to as an Arithmetic Logic Unit (ALU).

The registers 1918 are semiconductor-based structures to store data and/or instructions such as results of one or more of the operations performed by the AL circuitry 1916 of the corresponding core 1902. For example, the registers 1918 may include vector register(s), SIMD register(s), general purpose register(s), flag register(s), segment register(s), machine specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure including distributed throughout the core 1902 to shorten access time. The second bus 1922 may be implemented by at least one of an I2C bus, a SPI bus, a PCI bus, or a PCIe bus.

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages.

The microprocessor 1900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1900, in the same chip package as the microprocessor 1900 and/or in one or more separate packages from the microprocessor 1900.

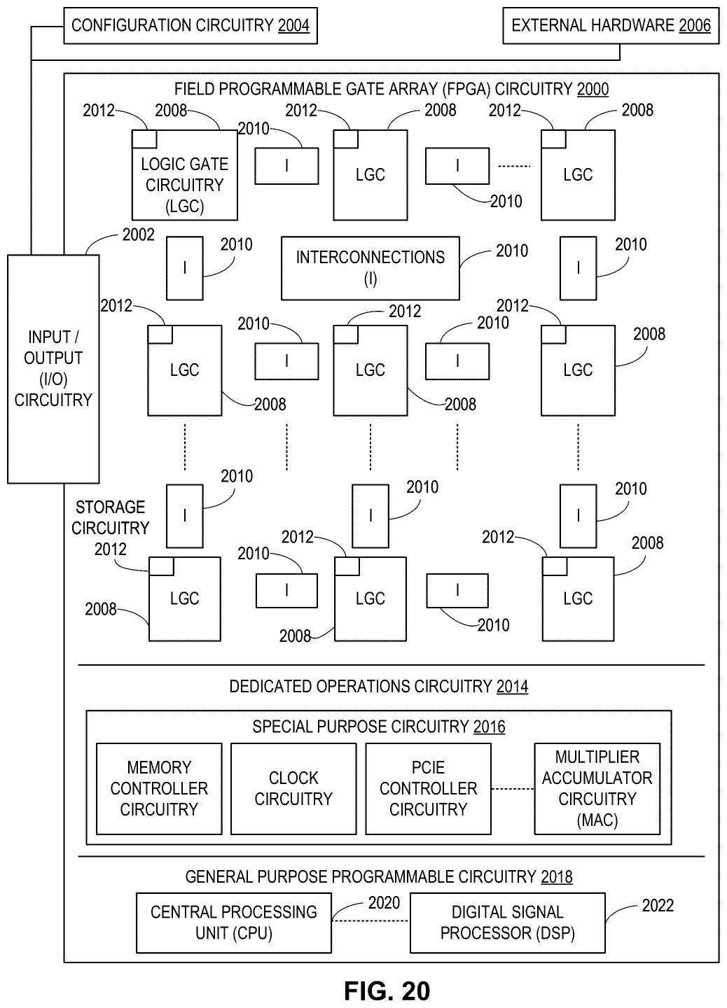

FIG. 20 is a block diagram of another example implementation of the programmable circuitry 1712, 1812 of FIGS. 17, 18. In this example, the programmable circuitry 1712 is implemented by FPGA circuitry 2000. For example, the FPGA circuitry 2000 may be implemented by an FPGA. The FPGA circuitry 2000 can be used, for example, to perform operations that could otherwise be performed by the example microprocessor 1900 of FIG. 19 executing corresponding machine readable instructions. However, once configured, the FPGA circuitry 2000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 2000 of FIG. 20 described above (which is a general purpose device that may be programmed to execute some or all of the machine readable instructions represented by the flowcharts of FIGS. 9-15 but whose interconnections and logic circuitry are fixed once fabricated), the FPGA circuitry 2000 of the example of FIG. 20 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 9-15. In particular, the FPGA 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 9-15. As such, the FPGA circuitry 2000 may be configured and/or structured to effectively instantiate some or all of the operations/functions corresponding to the machine readable instructions of the flowcharts of FIGS. 9-15 as dedicated logic circuits to perform the operations/functions corresponding to those software instructions in a dedicated manner analogous to an ASIC. Therefore, the FPGA circuitry 2000 may perform the operations/functions corresponding to the some or all of the machine readable instructions of FIGS. 9-15 faster than the general-purpose microprocessor can execute the same.

In the example of FIG. 20, the FPGA circuitry 2000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

The FPGA circuitry 2000 of FIG. 20, includes example input/output (I/O) circuitry 2002 to obtain and/or output data to/from example configuration circuitry 2004 and/or external hardware 2006. For example, the configuration circuitry 2004 may be implemented by interface circuitry that may obtain a binary file, which may be implemented by a bit stream, data, and/or machine-readable instructions, to configure the FPGA circuitry 2000, or portion(s) thereof. In some such examples, the configuration circuitry 2004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2006 may be implemented by external hardware circuitry. For example, the external hardware 2006 may be implemented by the microprocessor 1900 of FIG. 19.

The FPGA circuitry 2000 also includes an array of example logic gate circuitry 2008, a plurality of example configurable interconnections 2010, and example storage circuitry 2012. The logic gate circuitry 2008 and the configurable interconnections 2010 are configurable to instantiate one or more operations/functions that may correspond to at least some of the machine readable instructions of FIGS. 9-15 and/or other desired operations. The logic gate circuitry 2008 shown in FIG. 20 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations/functions. The logic gate circuitry 2008 may include other electrical structures such as look-up tables (LUTs), registers (e.g., flip-flops or latches), multiplexers, etc.

The configurable interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example dedicated operations circuitry 2014. In this example, the dedicated operations circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the programmable circuitry 1712, 1812 of FIGS. 17, 18, many other approaches are contemplated. For example, FPGA circuitry may include an on-board CPU, such as one or more of the example CPU 2020 of FIG. 20. Therefore, the programmable circuitry 1712, 1812 of FIGS. 17, 18 may additionally be implemented by combining at least the example microprocessor 1900 of FIG. 19 and the example FPGA circuitry 2000 of FIG. 20. In some such hybrid examples, one or more cores 2002 of FIG. 20 may execute a first portion of the machine readable instructions represented by the flowchart(s) of FIGS. 9-15 to perform first operation(s)/function(s), the FPGA circuitry 2000 of FIG. 20 may be configured and/or structured to perform second operation(s)/function(s) corresponding to a second portion of the machine readable instructions represented by the flowcharts of FIG. 9-15, and/or an ASIC may be configured and/or structured to perform third operation(s)/function(s) corresponding to a third portion of the machine readable instructions represented by the flowcharts of FIGS. 9-15.

It should be understood that some or all of the circuitry of FIG. 8 may, thus, be instantiated at the same or different times. For example, same and/or different portion(s) of the microprocessor 1900 of FIG. 19 may be programmed to execute portion(s) of machine-readable instructions at the same and/or different times. In some examples, same and/or different portion(s) of the FPGA circuitry 2000 of FIG. 20 may be configured and/or structured to perform operations/functions corresponding to portion(s) of machine-readable instructions at the same and/or different times.

In some examples, some or all of the circuitry of FIG. 8 may be instantiated, for example, in one or more threads executing concurrently and/or in series. For example, the microprocessor 1900 of FIG. 19 may execute machine readable instructions in one or more threads executing concurrently and/or in series. In some examples, the FPGA circuitry 2000 of FIG. 20 may be configured and/or structured to carry out operations/functions concurrently and/or in series. Moreover, in some examples, some or all of the circuitry of FIG. 8 may be implemented within one or more virtual machines and/or containers executing on the microprocessor 1900 of FIG. 19.

In some examples, the programmable circuitry 1712, 1812 of FIGS. 17, 18 may be in one or more packages. For example, the microprocessor 1900 of FIG. 19 and/or the FPGA circuitry 2000 of FIG. 20 may be in one or more packages. In some examples, an XPU may be implemented by the programmable circuitry 1712, 1812 of FIGS. 17, 18 which may be in one or more packages. For example, the XPU may include a CPU (e.g., the microprocessor 1900 of FIG. 19, the CPU 2020 of FIG. 20, etc.) in one package, a DSP (e.g., the DSP 2022 of FIG. 20) in another package, a GPU in yet another package, and an FPGA (e.g., the FPGA circuitry 2000 of FIG. 20) in still yet another package.

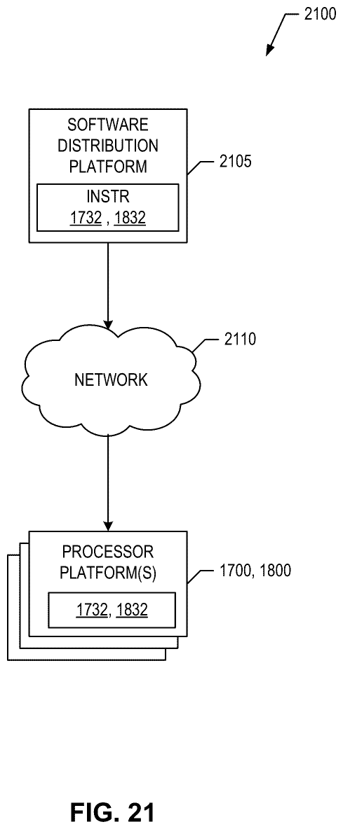

A block diagram illustrating an example software distribution platform 2105 to distribute software such as the example machine readable instructions 1732, 1832 of FIGS. 17, 18 to other hardware devices (e.g., hardware devices owned and/or operated by third parties from the owner and/or operator of the software distribution platform) is illustrated in FIG. 21. The example software distribution platform 2105 may be implemented by any computer server, data facility, cloud service, etc., capable of storing and transmitting software to other computing devices. The third parties may be customers of the entity owning and/or operating the software distribution platform 2105. For example, the entity that owns and/or operates the software distribution platform 2105 may be a developer, a seller, and/or a licensor of software such as the example machine readable instructions 1732, 1832 of FIGS. 17, 18. The third parties may be consumers, users, retailers, OEMs, etc., who purchase and/or license the software for use and/or re-sale and/or sub-licensing. In the illustrated example, the software distribution platform 2105 includes one or more servers and one or more storage devices. The storage devices store the machine readable instructions 1732, 1832 which may correspond to the example machine readable instructions of FIGS. 9-15, as described above. The one or more servers of the example software distribution platform 2105 are in communication with an example network 2110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1732, 1832 from the software distribution platform 2105. For example, the software, which may correspond to the example machine readable instructions of FIGS. 9-15, may be downloaded to the example programmable circuitry platforms 1700, 1800 which is to execute the machine readable instructions 1732, 1832 to implement the feature organizer circuitry 108. In some examples, one or more servers of the software distribution platform 2105 periodically offer, transmit, and/or force updates to the software (e.g., the example machine readable instructions 1732, 1832 of FIGS. 17, 18) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture preserve privacy in a user dataset in connection with recommendation system-based assessments. In examples disclosed herein, data having anonymous features is processed and output is generated with enriched data for training to improve accuracy. In examples disclosed herein, data usage type analysis, anonymous feature classification, enhanced feature engineering and/or feature selection can be performed to identify and select relevant features for training machine learning models with the selected features. As such, training score(s) can be identified without exposing any confidential information within the data, thereby protecting the privacy of the original input data, and improving overall data learnability. Methods and apparatus disclosed herein can be generalized to any recommendation systems, enriching feature numbers, identifying hidden information within the input datasets, and enhancing dataset expressivity.

Example methods, apparatus, systems, and articles of manufacture for preservation of privacy in a user dataset are disclosed herein. Further examples and combinations thereof include the following:

Example 1 includes an apparatus, comprising interface circuitry, machine readable instructions, and programmable circuitry to at least one of execute or instantiate the machine readable instructions to determine a data usage type for each one of a plurality of input user data features in a first dataset, classify the data usage type associated with each user data feature of the plurality of input user data features into a feature category, apply at least one feature engineering mechanism to feature categories of the data usage types of the plurality of input user data features, select, based on application of feature engineering, a subset of the plurality of input user data features for a feature selection training model, and output a second dataset based on the subset of the plurality of input user data features for the feature selection training model, the second dataset to include fewer user data features than the first dataset.

Example 2 includes the apparatus of example 1, wherein the data usage type associated with a user data feature is one of a binary feature, a specific feature, a categorical feature with a discrete value, or a numerical feature.

Example 3 includes the apparatus of example 1, wherein the programmable circuitry is to classify a data usage type to one of a first partite, a second partite, interaction between the first partite and the second partite or individual context feature.

Example 4 includes the apparatus of example 1, wherein the feature engineering mechanism to the feature categories of the data usage types includes target encoding using feature-to-feature encoding or multi-class target encoding.

Example 5 includes the apparatus of example 1, wherein the programmable circuitry is to perform feature selection by extracting feature importance by identifying features with lowest importance scores for removal from the plurality of input user data features.

Example 6 includes the apparatus of example 5, wherein the programmable circuitry is to train a gradient boosted decision tree (GBDT) based on the features with the lowest importance scores.

Example 7 includes the apparatus of example 6, wherein the programmable circuitry is to train the GBDT until (1) a number of remaining features reaches a predefined size, (2) an importance score is below a target threshold, or (3) observation of a model performance regression.

Example 8 includes a method comprising determining a data usage type for each one of a plurality of input user data features in a first dataset, classifying the data usage type associated with each user data feature of the plurality of user data features into a feature category, applying at least one feature engineering mechanism to feature categories of the data usage types of the plurality of input user data features, selecting, based on application of feature engineering, a subset of the plurality of input user data features for a feature selection training model, and outputting a second dataset based on the subset of the plurality of input user data features for the feature selection training model, the second dataset to include fewer user data features than the first dataset.

Example 9 includes the method of example 8, wherein the data usage type associated with a user data feature is one of a binary feature, a specific feature, a categorical feature with a discrete value, or a numerical feature.

Example 10 includes the method of example 8, further including classifying a data usage type to one of a first partite, a second partite, interaction between the first partite and the second partite or individual context feature.

Example 11 includes the method of example 8, wherein the feature engineering mechanism to the feature categories of the data usage types includes target encoding using feature-to-feature encoding or multi-class target encoding.

Example 12 includes the method of example 8, further including performing feature selection by extracting feature importance by identifying features with lowest importance scores for removal from the plurality of input user data features.

Example 13 includes the method of example 8, further including training a gradient boosted decision tree (GBDT) based on the features with the lowest importance scores.

Example 14 includes the method of example 13, further including training the GBDT until (1) a number of remaining features reaches a predefined size, (2) an importance score is below a target threshold, or (3) observation of a model performance regression.

Example 15 includes a non-transitory machine readable storage medium comprising instructions to cause programmable circuitry to at least determine a data usage type for each one of a plurality of input user data features in a first dataset, classify the data usage type associated with each user data feature of the plurality of input user data features into a feature category, apply at least one feature engineering mechanism to feature categories of the data usage types of the plurality of input user data features, select, based on application of feature engineering, a subset of the plurality of input user data features for a feature selection training model, and output a second dataset based on the subset of the plurality of input user data features for the feature selection training model, the second dataset to include fewer user data features than the first dataset.

Example 16 includes the non-transitory machine readable storage medium of example 15, wherein the data usage type associated with a user data feature is one of a binary feature, a specific feature, a categorical feature with a discrete value, or a numerical feature.

Example 17 includes the non-transitory machine readable storage medium of example 15, wherein the instructions are to cause the programmable circuitry to classify a data usage type to one of a first partite, a second partite, interaction between the first partite and the second partite or individual context feature.

Example 18 includes the non-transitory machine readable storage medium of example 15, wherein the feature engineering mechanism to the feature categories of the data usage types includes target encoding using feature-to-feature encoding or multi-class target encoding.

Example 19 includes the non-transitory machine readable storage medium of example 15, wherein the instructions are to cause the programmable circuitry to perform feature selection by extracting feature importance by identifying features with lowest importance scores for removal from the plurality of input user data features.

Example 20 includes the non-transitory machine readable storage medium of example 19, wherein the instructions are to cause the programmable circuitry to train a gradient boosted decision tree (GBDT) based on the features with the lowest importance scores.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine readable instructions; and
programmable circuitry to at least one of execute or instantiate the machine readable instructions to:
determine a data usage type for each one of a plurality of input user data features in a first dataset;
classify the data usage type associated with each user data feature of the plurality of input user data features into a feature category;
apply at least one feature engineering mechanism to feature categories of the data usage types of the plurality of input user data features;
select, based on application of feature engineering, a subset of the plurality of input user data features for a feature selection training model; and
output a second dataset based on the subset of the plurality of input user data features for the feature selection training model, the second dataset to include fewer user data features than the first dataset.

2. The apparatus of claim 1, wherein the data usage type associated with a user data feature is one of a binary feature, a specific feature, a categorical feature with a discrete value, or a numerical feature.

3. The apparatus of claim 1, wherein the programmable circuitry is to classify a data usage type to one of a first partite, a second partite, interaction between the first partite and the second partite or individual context feature.

4. The apparatus of claim 1, wherein the feature engineering mechanism to the feature categories of the data usage types includes target encoding using feature-to-feature encoding or multi-class target encoding.

5. The apparatus of claim 1, wherein the programmable circuitry is to perform feature selection by extracting feature importance by identifying features with lowest importance scores for removal from the plurality of input user data features.

6. The apparatus of claim 5, wherein the programmable circuitry is to train a gradient boosted decision tree (GBDT) based on the features with the lowest importance scores.

7. The apparatus of claim 6, wherein the programmable circuitry is to train the GBDT until (1) a number of remaining features reaches a predefined size, (2) an importance score is below a target threshold, or (3) observation of a model performance regression.

8. A method comprising:
determining a data usage type for each one of a plurality of input user data features in a first dataset;
classifying the data usage type associated with each user data feature of the plurality of user data features into a feature category;
applying at least one feature engineering mechanism to feature categories of the data usage types of the plurality of input user data features;
selecting, based on application of feature engineering, a subset of the plurality of input user data features for a feature selection training model; and
outputting a second dataset based on the subset of the plurality of input user data features for the feature selection training model, the second dataset to include fewer user data features than the first dataset.

9. The method of claim 8, wherein the data usage type associated with a user data feature is one of a binary feature, a specific feature, a categorical feature with a discrete value, or a numerical feature.

10. The method of claim 8, further including classifying a data usage type to one of a first partite, a second partite, interaction between the first partite and the second partite or individual context feature.

11. The method of claim 8, wherein the feature engineering mechanism to the feature categories of the data usage types includes target encoding using feature-to-feature encoding or multi-class target encoding.

12. The method of claim 8, further including performing feature selection by extracting feature importance by identifying features with lowest importance scores for removal from the plurality of input user data features.

13. The method of claim 8, further including training a gradient boosted decision tree (GBDT) based on the features with the lowest importance scores.

14. The method of claim 13, further including training the GBDT until (1) a number of remaining features reaches a predefined size, (2) an importance score is below a target threshold, or (3) observation of a model performance regression.

15. A non-transitory machine readable storage medium comprising instructions to cause programmable circuitry to at least:
determine a data usage type for each one of a plurality of input user data features in a first dataset;
classify the data usage type associated with each user data feature of the plurality of input user data features into a feature category;
apply at least one feature engineering mechanism to feature categories of the data usage types of the plurality of input user data features;
select, based on application of feature engineering, a subset of the plurality of input user data features for a feature selection training model; and
output a second dataset based on the subset of the plurality of input user data features for the feature selection training model, the second dataset to include fewer user data features than the first dataset.

16. The non-transitory machine readable storage medium of claim 15, wherein the data usage type associated with a user data feature is one of a binary feature, a specific feature, a categorical feature with a discrete value, or a numerical feature.

17. The non-transitory machine readable storage medium of claim 15, wherein the instructions are to cause the programmable circuitry to classify a data usage type to one of a first partite, a second partite, interaction between the first partite and the second partite or individual context feature.

18. The non-transitory machine readable storage medium of claim 15, wherein the feature engineering mechanism to the feature categories of the data usage types includes target encoding using feature-to-feature encoding or multi-class target encoding.

19. The non-transitory machine readable storage medium of claim 15, wherein the instructions are to cause the programmable circuitry to perform feature selection by extracting feature importance by identifying features with lowest importance scores for removal from the plurality of input user data features.

20. The non-transitory machine readable storage medium of claim 19, wherein the instructions are to cause the programmable circuitry to train a gradient boosted decision tree (GBDT) based on the features with the lowest importance scores.
